(19) United States
(12) Patent Application Publication
(10) Pub. No.: US 2025/0224148 A1
(43) Pub. Date: Jul. 10, 2025

(54) Solar Panel Installation Alignment Systems

(71) Applicant: Sarcos Corp., Salt Lake City, UT (US)

(72) Inventors: Fraser M. Smith, Salt Lake City, UT (US); Matthew Torok, Cary, NC (US)

(21) Appl. No.: 19/014,062

(22) Filed: Jan. 8, 2025

Related U.S. Application Data
(60) Provisional application No. 63/618,810, filed on Jan. 8, 2024.

(51) Int. Cl. H02S 30/10; H02S 40/22

(52) U.S. Cl. CPC H02S 30/10; H02S 40/22

(57) ABSTRACT

A solar panel alignment system can include a plurality of bi-directional panel mounts connected to or connectable to a torque tube. The bi-directional panel mounts may each include a first retaining feature assembly to receive a first side of a first support frame or a first support rail of a first solar panel, and a second retaining feature assembly configured to receive a second side of a second support frame or second support rail of a second solar panel. In this example, one or both of the first retaining feature assembly or the second retaining feature assembly includes an alignment structure to ensure lateral edges of the first solar panel are aligned with lateral edges of the second solar panel when the first solar panel and the second solar panel are fully engaged with the first retaining feature and the second retaining feature, respectively.

### RELATED APPLICATIONS

This application claims the benefit of U.S. Provisional Application Ser. No. 63/618,810, filed Jan. 8, 2024, and entitled, “Solar Panel Installation Alignment Systems” which is incorporated by reference in its entirety herein.

This application is also related to U.S. Application Ser. No. ______, filed Jan. 8, 2025, and entitled, “Solar Panel Mounting Systems and Methods” (Attorney Docket No. 4000-23.0014.US.NP); U.S. Application Ser. No. ______, filed Jan. 8, 2025, and entitled, “Torque Tube Clamps for Automated Solar Panel Installation” (Attorney Docket No. 4000-23.0015.US.NP); U.S. Application Ser. No. ______, filed Jan. 8, 2025, and entitled, “Dispensing Hopper and Presentation System for Overhead Installation of Solar Panels for A Solar Tracking System” (Attorney Docket No. 4000-23.0016.US.NP); U.S. Application Ser. No. ______, filed Jan. 8, 2025, and entitled, “Solar Panel Installation Vehicles as Part of a Solar Panel Installation System for A Solar Tracking System” (Attorney Docket No. 4000-23.0018.US.NP); and U.S. Application Ser. No. ______, filed Jan. 8, 2025, and entitled, “Support Clamp Installation Vehicles as Part of a Solar Panel Installation System for A Solar Tracking System” (Attorney Docket No. 4000-23.0019.US.NP), each of which is incorporated by reference in its entirety herein.

### BACKGROUND

In recent years, electricity generation through the use of solar panels has become much more common and widespread then has been previously known. Solar panels and solar panel arrays are commonly installed on both commercial and residential buildings, as well as other structures. Additionally, large solar panel arrays are commonly installed on mounts in open fields and spaces.

With solar panel arrays and solar panel installation becoming more common in society, quicker and more efficient ways of installing solar panels are necessary in order to increase rates and decrease costs at which solar panel arrays can be installed. For this reason, systems, devices, and methods for installing solar panels continue to be developed. Furthermore, mounts and supports for receiving solar panels that can work well for both manual installation or with installation devices continue to be developed in order to facilitate quick and efficient installation and operation of solar panels with installation devices.

### BRIEF DESCRIPTION OF THE DRAWINGS

Features and advantages of the invention will be apparent from the detailed description which follows, taken in conjunction with the accompanying drawings, which together illustrate, by way of example, features of the invention; and, wherein:

FIG. 1A illustrates a perspective view of an example automated overhead solar panel assembly vehicle for installing solar panels along a torque tube in accordance with the present disclosure;

FIG. 1B illustrates a perspective view of an example pair of vehicles coordinated by precision GPS for automated overhead solar panel installation along a torque tube in accordance with the present disclosure;

FIG. 2A illustrates an example frameless solar panel including a solar panel element mounted on support rails in accordance with the present disclosure;

FIG. 2B illustrates an example solar panel including a solar panel element mounted in a support frame in accordance with the present disclosure;

FIGS. 3A-3C illustrate a partial perspective view of an example drive mounting clamp coupled with a torque tube, with the drive mounting clamp also attached to a panel mount at various stages of overhead insertion of a solar panel into the panel mount in accordance with the present disclosure;

FIGS. 4A-4D illustrate an example automation tool inserting a solar panel into a spring-loaded panel mount at various stages of overhead insertion of a solar panel into the panel mount in accordance with the present disclosure;

FIGS. 5A-5B illustrate an example pivotable spring-loaded panel mount at various stages of overhead insertion of a solar panel into the panel mount in accordance with the present disclosure;

FIGS. 6A-6B illustrate an alternative example pivotable spring-loaded panel mount at various stages of overhead insertion of a solar panel into the panel mount in accordance with the present disclosure;

FIGS. 7A-7C illustrate another alternative example pivotable panel mount at various stages of overhead insertion of a solar panel into the panel mount in accordance with the present disclosure;

FIGS. 8A-8C illustrate an example panel mount with spring-loaded pins at various stages of overhead insertion of a solar panel into the panel mount in accordance with the present disclosure;

FIGS. 9A-9B illustrate an example panel mount with an engagement pin (or a multi-level engagement pin) that is spring-loaded for lateral (sliding) insertion of a solar panel into the panel mount in accordance with the present disclosure;

FIGS. 10A-10D illustrate an alternative example panel mount with a plurality of multi-level engagement pins that are spring-loaded at various stages of lateral (sliding) insertion of a solar panel into the panel mount in accordance with the present disclosure;

FIGS. 11A-11C illustrate an example panel mount with a lever-assisted spring-loaded pin at various stages of lateral (sliding) insertion of a solar panel into the panel mount in accordance with the present disclosure;

FIGS. 12A-12B illustrate an example panel mount with a lever-assisted (and in some instances, spring-loaded) pin for lateral (sliding) insertion of a solar panel into the panel mount in accordance with the present disclosure;

FIGS. 13A-13B illustrate an example panel mount with an alternative lever-assisted spring-loaded pin at various stages of lateral (sliding) insertion of a solar panel into the panel mount in accordance with the present disclosure;

FIGS. 14A-14D illustrate an example panel mount with an alternative lever-assisted spring-loaded pin at various stages of overhead insertion of a solar panel into the panel mount in accordance with the present disclosure;

FIGS. 15A-15C illustrate an example panel mount with spring-loaded pins at various stages of overhead insertion of a solar panel into the panel mount in accordance with the present disclosure;

FIG. 16 illustrates an example solar panel mounting and alignment system including multiple panel mounts with lead-in latches positioned along a torque tube in accordance with the present disclosure;

FIGS. 17A-17D illustrate various views of a panel mount with a lead-in latch assembly suitable for lateral (sliding) insertion of a solar panel into the panel mount in accordance with the present disclosure;

FIGS. 18A-18D illustrate an example of operation of a panel mount with a lead-in latch assembly in accordance with the present disclosure;

FIG. 19 illustrates an alternative example panel mount with a lead-in latch assembly in the form of an elastically deflectable cantilevered beam in accordance with the present disclosure;

FIG. 20 illustrates an example panel mount with a spring-loaded pin in accordance with the present disclosure;

FIGS. 21A-21C illustrate an example flexible panel mount at various stages of overhead insertion of a solar panel into the panel mount in accordance with the present disclosure;

FIGS. 22-25 illustrate various example flexible panel mounts suitable for overhead insertion of a solar panel into the panel mount in accordance with the present disclosure;

FIGS. 26A-26B illustrate example flexible panel mounts that are laterally offset to reduce space between adjacent solar panels, and which are suitable for overhead insertion of a solar panel into the panel mount in accordance with the present disclosure;

FIGS. 27A-27C illustrate an example flexible panel mount at various stages of overhead insertion of a solar panel into the panel mount in accordance with the present disclosure;

FIGS. 28A-28D illustrate an example panel mount with an over-center linkage locking mechanism at various stages of overhead insertion of a solar panel into the panel mount in accordance with the present disclosure;

FIGS. 29A-29D illustrate an example panel mount with an alternative over-center linkage locking mechanism at various stages of overhead insertion of a solar panel into the panel mount in accordance with the present disclosure;

FIGS. 30A-30C illustrate an example torque tube clamp at multiple stages of engagement with a cross-sectional octagon torque tube and a multi-linkage bar locking mechanism in accordance with the present disclosure;

FIG. 31A illustrates a perspective view of an example torque tube clamp similar to that shown in FIGS. 30A-30C, where the clamp support is in the form of a panel mount for receiving solar panels in accordance with the present disclosure;

FIG. 31B illustrates a perspective view of an example torque tube clamp similar to that shown in FIGS. 30A, except that rather than the torque tube collar having an octagon-shaped inner profile, the inner profile is an arcuate shape suitable for use with a round torque tube in accordance with the present disclosure;

FIGS. 32A-32B illustrate another example torque tube clamp at multiple stages of engagement with a cross-section square torque tube and an over-center linkage locking mechanism in accordance with the present disclosure;

FIGS. 33A-33B illustrate an example torque tube clamp at multiple stages of engagement with a cross-sectional octagon torque tube and an over-center linkage locking mechanism in accordance with the present disclosure;

FIGS. 34A-34B illustrate an example torque tube clamp at multiple stages of engagement with a cross-sectional square torque tube and over-center linkages actuated by engagement lever arms in accordance with the present disclosure;

FIGS. 35A-35B illustrate an example torque tube clamp at multiple stages of engagement with a cross-sectional square torque tube and a retractable ground bar locking mechanism in accordance with the present disclosure;

FIG. 36A illustrates an example torque tube clamp at multiple stages of engagement with a cross-sectional octagon torque tube and an over-center linkage locking mechanism, with the clamp support being in the form of a panel mount in accordance with the present disclosure;

FIG. 36B illustrates a cross-section of the panel mount shown in FIG. 36A in accordance with the present disclosure;

FIG. 37A illustrates an example torque tube clamp at multiple stages of engagement with a cross-sectional octagon torque tube and a multi-linkage bar locking mechanism, with the clamp support being in the form of a panel mount in accordance with the present disclosure;

FIG. 37B illustrates a cross-sectional and partial cutaway view of the panel mount shown in FIG. 11A in accordance with the present disclosure.

FIG. 38 illustrates an example panel mount clamp assembly with a panel mount including rotatable retaining channels similar to that shown and described in connection with FIG. 7A-7C in accordance with the present disclosure;

FIG. 39 illustrates an end view of an example panel mount clamp assembly with a panel mount including a lead-in latch assembly similar to that shown and described in connection with FIGS. 16-20 in accordance with the present disclosure;

FIG. 40 illustrates an example panel mount clamp assembly with a panel mount including a lead-in latch assembly similar to that shown and described in connection with FIG. 28A-29D in accordance with the present disclosure; and

FIGS. 41A-41B illustrate an example panel mount clamp assembly including multiple panel mounts attached to a clamp support of torque tube clamp and multiple solar panels also attached to the panel mounts after over overhead insertion into the panel mounts in accordance with the present disclosure.

### DETAILED DESCRIPTION

In accordance with examples of the present disclosure, a solar panel alignment system can include a plurality of bi-directional panel mounts connected to or connectable to a torque tube. The bi-directional panel mounts may each include a first retaining feature assembly to receive a first side of a first support frame or a first support rail of a first solar panel, and a second retaining feature assembly configured to receive a second side of a second support frame or second support rail of a second solar panel. In this example, one or both of the first retaining feature assembly or the second retaining feature assembly includes an alignment structure to ensure lateral edges of the first solar panel are aligned with lateral edges of the second solar panel when the first solar panel and the second solar panel are fully engaged with the first retaining feature and the second retaining feature, respectively. In some examples, the alignment system can provide for solar panel alignment during installation in three directions, including alignment of the lateral edges of adjacently installed solar panels, wherein the lateral edges are positioned in parallel with the torque tube, centering alignment of individual solar panels to provide substantially equal spacing between adjacently installed solar panels, and rotational alignment of installed solar panels to follow rotation of the torque tube without rotational slippage. These solar panel alignment systems may be suitable and adapted for installation by automation, in some examples.

In other examples, a solar panel alignment system can include a plurality of panel mounts connectable or connected to a torque tube, the panel mounts each including a first retaining feature assembly to receive a first side of a first support frame or a first support rail of a first solar panel, and a second retaining feature assembly configured to receive a second side of a second support frame or second support rail of a second solar panel. The solar panel alignment system may also include an automated solar panel insertion vehicle adapted to sequentially install solar panels along the torque tube using an automated solar panel insertion vehicle including sensory equipment for sensing alignment or misaligned lateral edges of a plurality of solar panels being installed into the plurality of panel mounts when connected to the torque tube. The sensory equipment may communicate with installation mechanisms to adjust the misaligned lateral edges of one or more of the multiple solar panels based on data collected by the sensory equipment. Example sensory equipment that may be used includes one or more of an alignment laser or a perception sensor. Retaining features that may be present may include fixed retaining channels, biasing structures, pivoting retaining channels, spring-loaded pins, fixed pins functionally coupled with a biasing structures, rotatable pin assemblies, levered pin assemblies, flexible structures with retaining buttons, lead-in latch assemblies, panel-side snaps, or a combination thereof. The panel mounts may be bi-directional in some examples.

In another example, a method of installing and aligning solar panels can include coupling a plurality of bi-directional panel mounts at multiple locations along an elongated torque tube, with distance intervals suitable for receiving and retaining a plurality of solar panels individually installed between immediately adjacent bi-directional panel mounts. The plurality of bi-directional panel mounts may include a retaining feature assembly a first retaining feature assembly to receive a first side of a first support frame or a first support rail of a first solar panel, and a second retaining feature assembly configured to receive a second side of a second support frame or second support rail of a second solar panel. One or both of the first retaining feature assembly or the second retaining feature assembly can include an alignment structure to ensure lateral edges of the first solar panel are aligned with lateral edges of the second solar panel when the first solar panel and the second solar panel are fully engaged with the first retaining feature and the second retaining feature, respectively. The method can further include installing the plurality of solar panels between the immediately adjacent bi-directional panel mounts to engage with the first retaining feature, the second retaining feature, or both such that the first solar panel and the second solar panel are laterally aligned.

In another example, a method of aligning and installing solar panels can include coupling a plurality of panel mounts at multiple locations along an elongated torque tube, with distance intervals suitable for receiving and retaining a plurality of solar panels individually installed between immediately adjacent panel mounts. The plurality of panel mounts can include a first retaining feature assembly to receive a first side of a first support frame or a first support rail of a first solar panel, and a second retaining feature assembly configured to receive a second side of a second support frame or second support rail of a second solar panel. The method can also include installing the plurality of solar panels between the immediately adjacent panel mounts using an automated solar panel insertion vehicle with sensory equipment for sensing alignment or misaligned lateral edges of a plurality of solar panels being installed into the plurality of panel mounts when connected to the torque tube. The sensory equipment can communicate with installation mechanisms to adjust the misaligned lateral edges of one or more of the multiple solar panels based on data collected by the sensory equipment.

Additional features and advantages of the disclosed method and apparatus are described in, and will be apparent from, the following Detailed Description and the Figures. The features and advantages described herein are not all-inclusive and, in particular, many additional features and advantages will be apparent to one of ordinary skill in the art in view of the figures and description. Moreover, it should be noted that the language used in the specification has been principally selected for readability and instructional purposes, and not to limit the scope of the inventive subject matter.

It is noted that when discussing the solar panel alignment systems or the methods of installing and aligning solar panels described herein, these discussions are considered applicable to other examples whether or not they are explicitly discussed in the context of that example unless expressly indicated otherwise. Thus, for example, when discussing a certain panel mount in the context of the solar panel alignment systems, such disclosure is also relevant to and directly supported in context of the methods of installing and alignment solar panels, and vice versa.

For simplicity and illustrative purposes, numerous specific details are set forth in order to provide a thorough understanding of the present disclosure. It will be readily apparent however, that the present disclosure can be practiced without limitation to some of these specific details. In other instances, certain methods, systems, materials, and structures have not been described in detail so as not to obscure the present disclosure.

Furthermore, reference numerals are used uniformly herein, so for clarity, in certain instances, a reference numeral may be shown in a specific figure but may not be specifically discussed to avoid unnecessary redundancy.

### Automated Panel Installation of Framed and Frameless Solar Panels

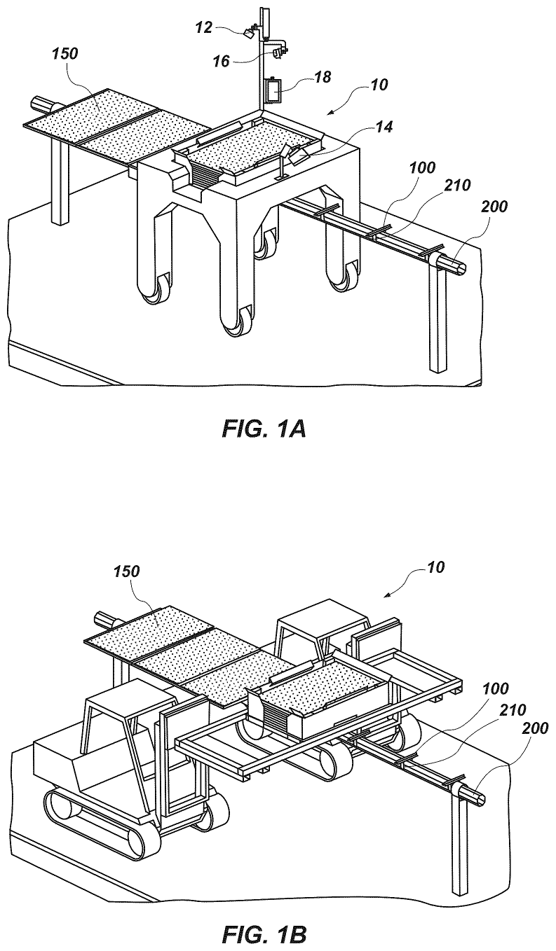

Referring now to FIGS. 1A and 1B, a few automated panel installation vehicles or vehicle systems are shown at 10. More specifically, FIG. 1A illustrates an automated panel installation vehicle that rides over the top and straddles a torque tube 200 for overhead solar panel 150 installation. FIG. 1B illustrates an automated panel installation vehicle system which includes multiple vehicles that can be coordinated and controlled using a GPS device for overhead solar panel installation. For example, RTKGPS may be used to move two machines together, in some instances within very small tolerances. In further detail, similar automated vehicles can be configured for lateral (slidable) solar panel insertion. For purposes of alignment of the solar panels during installation, there are several mechanical features described in greater detail hereinafter. However, it is noted that the automated panel installation vehicles or vehicle systems can be equipped with sensory equipment, such as laser alignment features 16, perception sensors (cameras) 12 and 16, etc. For example, as shown by way of example, a few different alignment features are shown, which may include perception sensors positioned on the automated vehicle in the example shown, as well as a laser alignment device. In some examples, there may also be a display or control interface 18 for inputting and/or receiving information regarding the automated panel installation vehicle(s) or systems, as well as various safety features, such as sound emitters, light emitters, etc. Furthermore, in both examples, the torque tube has been outfitted with a series of torque tube clamps 210 each having a panel mount 100 attached thereto. The panel mounts are spaced apart at a distance suitable for receiving and retaining a series of solar panels being installed sequentially. In other examples (not shown), a single machine may be used on one side for lateral solar panel insertion, e.g., sliding between adjacent panel mounts, mounting from overhead by angled insertion, etc.

There are a number of ways of detecting a given fiducial that may be present on a solar panel and/or on a panel mount to assist with proper automated alignment of the solar panels being installed in rows over a torque tube. Essentially, a “fiducial” or a “fiducial marker” refers to an object(s), marking(s) and/or integrated structure(s) associated with the solar panel and/or the panel mount. A fiducial may be likewise in the form of a marking(s) or structure(s) that is part of the imaging equipment, such as in the form of a reticle, etc. The fiducial is typically in the field of view of an imaging or sensing system, which is used for a point of reference for the equipment to sense and place or adjust solar panels during installation. Thus, these fiducials may be detectable on an already-installed solar panel or while installing a solar panel or a panel mount or a panel mount clamp assembly and/or may be present as part of imaging equipment, such as in the form of a reticle. For example, one or more cameras, LIDARS, IR-based sensors, ultrasonic sensors, structured light, or the light could be used to sense these fiducials. Other examples may include the use of a ferromagnetic element(s) in an otherwise non-ferromagnetic structure that would be detected by a magnet-based sensor, or a magnet may be used that is detectable by a Hall Effect sensor. In still other examples, RFID tags could be included in the panel mount or panel mount assemblies to provide proper alignment during installation and/or adjustment after installation. Other examples may include providing spots, lines, shapes, or other marking details (engraved, etched, printed, or otherwise present) that reflect a known light frequency or frequencies, thereby being easily readable by the sensing equipment, such as by being highly illuminated or bright when the appropriate wavelength of energy is used to illuminate the markings. In other examples, fiducials may likewise provide imaging details when a laser is shone at them, indicating alignment or a direction of misalignment to be corrected. For example, the fiducial may be in the form of multiple holes, with a second hole including a reflector at a known location, e.g., the center of the structure, which would indicate proper alignment by reflection. In some examples, if misaligned, the reflection could be engineered to generate a color or wavelength spectrum, or vice versa. Essentially, the automated panel installation vehicle(s) or systems may be designed to sense the correct location for alignment by these or any of a number of other approaches to provide for proper alignment of the solar panels during solar panel installation.

Alternatively, or in addition to the perception sensors, there the panel installation vehicle or vehicles may include mechanical guides for installation alignment. Mechanical guides may include various features on the mechanical guides that allow the panel installation vehicle to ensure proper placement and/or alignment. For example, mechanical guides may include one or more arms with stoppers or other structures to not allow the panel installation vehicle or vehicles to install the solar panels beyond a certain location and/or to not allow installation or disengagement from the solar panel at a location prior to being aligned properly.

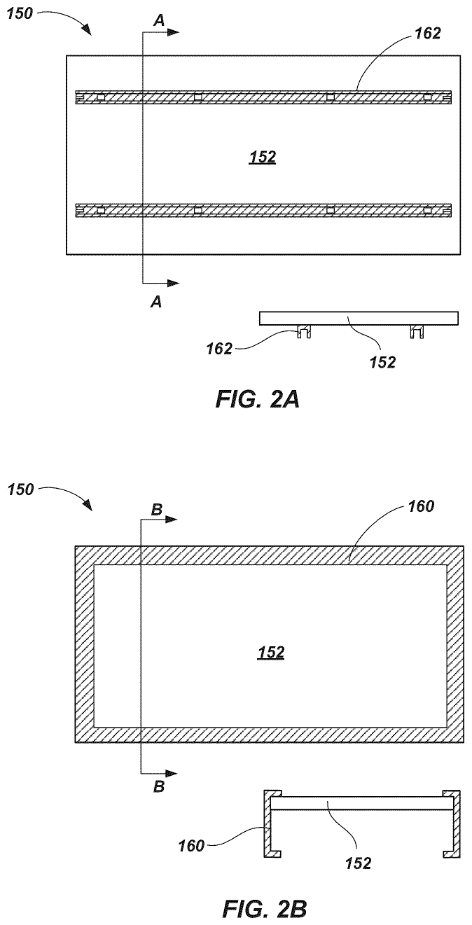

FIGS. 2A and 2B illustrate two different types of solar panels 150 that can be used in accordance with the present disclosure. FIG. 2A illustrates a frameless solar panel, which includes a solar panel element 152, e.g., PV, supported from underneath by a pair of support rails 162. A cross-sectional view of the frameless solar panel is shown at A-A for additional clarity. FIG. 2B illustrates a support framed solar panel, which includes the solar panel element, but rather than support rails, the solar panel element is supported by an exterior support frame 160 that essentially follows and retains the edges of the solar panel element. A cross-sectional view of the support framed solar panel is shown at B-B for additional clarity. It is noted that the panel mounts described herein are typically intended to interface with either the support frame of a solar panel or the support rails of the solar panel. In each of the examples herein, and particularly in the drawings, the illustrated example typically depicts the interface between the panel mount(s) and a panel support frame. However, it is noted that simple modification of size or other minor modification can be carried out to join the panel mount(s) with the support rails, and thus is considered to be part of the present disclosure.

In more specific detail regarding controlling the robotic systems and/or any of the assemblies, subassemblies, or subsystems thereof, any robotic systems, including computing systems, controllers, machine learning, or the like can be used with the automated panel installation of framed and/or frameless solar panels as described herein. For example, computing systems or controllers usable with the robotic systems or assemblies, subassemblies, or subsystems thereof can include any of a number of processors, I/O devices, network devices, and memory devices. The memory devices may include a data store and/or various modules. The computing systems or controllers may be connected with a display and/or control interface, for example, for human interface with the computing systems or controllers, for example. For example, various controller(s) may include and/or cooperate with any processor, server, system, device, computing device, other controller, microprocessor, microcontroller, microchip, semiconductor device, computer network, cloud computing, artificial intelligence (AI), machine learning, deep learning, or the like. The controller(s) may be configurable or configured to perform or enable autonomous, semi-autonomous, and/or user-controller managing, including controlling, monitoring, etc., of one or more elements, aspects, functionalities, operations, and/or processes of the robotic system. In some examples, the controller(s) may be configurable or configured to manage and/or control one or more elements, aspects, functionalities, operations, and/or processes of the mobile vehicle(s) (or any other structure that where an object managing system is mounted). For example, the controller(s) may be configurable or configured to manage, control movement, and or coordination of the mobile vehicle from one location to another location, including controlling one or more panel installation hoppers, robotic arms, robotic levers, wheels, stabilizing assemblies, variety of perception sensors, laser alignment features, sound emitters, light emitters, power sources, etc. In a specific example regarding perception sensing, the controller(s) can access and control optical cameras, IR cameras, LIDAR sensors, and any sensors to facilitate recognition and locating of one or more solar panels to be installed in one or more panel mounts, one or more torque tube clamps onto a torque tube, etc. For instance, the controller(s) can receive a two-dimensional (2D) image from an optical camera for processing to roughly locate an object, e.g., a target object, using machine vision techniques, such as edge detection or blob analysis. The controller(s) can also (or alternatively) receive three-dimensional (3D) data from a stereo image provided by a pair of optical cameras configured to facilitate stereo imaging or IR cameras. The data can be analyzed to map a precise location and orientation of the target object, as well as other, etc., at or around the target object. The controller(s) can operate as a perception sensors for the robotic system or any subassembly thereof to assist in installing a solar panel, a panel mount, a torque tube clamp, or a panel mount clamp assembly at any location along a torque tube. Such perception sensors in combination with the controller(s) can likewise access other sensors, such as a force sensor, a LIDAR sensor and/or a rangefinder sensor to provide additional 2D and 3D information about the surroundings and operation of the various components of the robotic systems.

It is noted herein that any of the controller(s) discussed and disclosed herein can comprise similar components that function similarly. It is also noted that any of the controller(s) discussed and disclosed herein can be configured to communicate and control any of the elements of the systems, subsystems, assemblies, subassemblies, devices, components, etc., of the robotic system, not just the particular components of the specific device or system in which the controller(s) reside. For example, a controller located within the mobile vehicle or installation hopper can control any components or all components of the object managing system or systems. Controller(s) may also be located remotely, connecting wirelessly with any component of the robotic system. However configured or wherever located, the controller(s) can include all of the hardware and/or software components to facilitate the communication and control of the robotic system or components thereof with respect to whatever example robotics are designed and implemented in accordance with the present disclosure.

### Solar Panel Alignment Systems

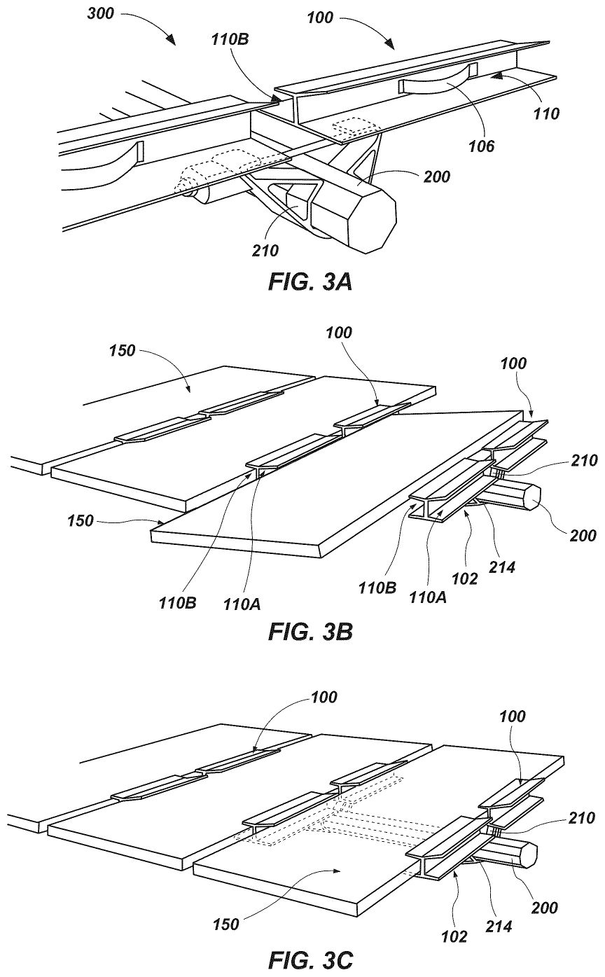

As an initial matter, the solar panel alignment systems may include a panel mount (or a bi-directional panel mount) attached to, attachable to, or integrated with a torque tube clamp to form a panel mount clamp assembly. These two structures are shown separately in many instances, and combined together in many instances. It is understood that to show each and every example of torque tube clamps combined with panel mounts (or bi-directional panel mounts) would generate too many examples, so for clarity, each of the panel mounts and the torque tube clamps are shown separately, and in some cases, a few examples are combined to illustrate a few panel mount clamp assembly. With that in mind, any panel mount (or bi-directional panel mount) can be combined with any torque tube clamp illustrated or described herein, often without modification or with limited modification in accordance with the teachings of the present disclosure. Furthermore, any of the panel mounts shown and described herein can be modified to include an alignment structure, even one is not shown in a given example. For example, FIGS. 3A-3C illustrate an example solar panel mounting and alignment system that can be modified to include a pin, protrusion, latch, retaining button, snap, etc., as described herein. Thus, mention of a “solar panel mounting system,” a “panel mount clamp assembly,” or the like expressly provides disclosure as it relates to panel mount alignment systems and methods of installing and aligning solar panels in accordance with the present disclosure, either by using the unmodified structure as shown, or by modification to include an alignment structure in accordance with the description herein, or by the use of sensory perception equipment that may be present on an automated panel insertion vehicle.

Example alignment structure may be in the form of a pin or protrusion can be adapted to be received by a panel support aperture when installing the solar panel. Thus, the pin or protrusion and the panel support aperture may each be positioned to ensure alignment of the lateral edges of adjacently installed solar panels. In other examples, the alignment structure may be in the form of a fixed pin. For example, a first fixed pin may be a first retaining feature and a second fixed pin that is shorter in length than the first fixed pin may be a second retaining feature. In this arrangement, the first retaining feature assembly may also include a biasing structure or spring. In another example, an alignment structure may include a spring-loaded pin, such as spring-loaded pin associated with an engagement lever that engages with a solar panel being installed at one or both of the first or second retaining feature assemblies, a spring-loaded pin is associated with a rotatable pin assembly that engages with a solar panel being installed at one or both of the first or second retaining feature assemblies, or a spring-loaded pin is associated with a multi-level engagement pin or a toggle-type engagement pin. In other examples, an alignment structure may include a pin or protrusion as part of a lead-in latch assembly. Example lead-in latch assemblies may include a facial lead-in latch and an edge lead-in latch as part of the first retaining feature assembly. In other examples, the lead-in latch assembly may include a second facial lead-in latch as part of the second retaining feature assembly. Another alignment structure may include a flexible structure with a retaining button that engages with a panel support aperture. Thus, the retaining button and the panel support aperture are each positioned to ensure alignment of the lateral edges of adjacently installed solar panels. In other examples, the alignment structure can include a panel-side snap including a flexible standoff and a retaining button that engages with a panel support aperture. In this example, the panel-side snap and the panel support aperture are each positioned to ensure alignment of the lateral edges of adjacently installed solar panels. In other examples, the alignment structure may include a retaining channel with a stopper structure suitable for ensuring that a solar panel is not installed laterally beyond the stopper structure. In some examples, the alignment structure can be present as part of an over-center linkage assembly. In some examples, in addition to the alignment structure(s), at least one of the first retaining feature assembly or the second retaining feature assembly includes retention structure to retain the solar panel at the support frame or support rail. Example retention structures may include, for example a retaining channel, a flexible structure with a retaining button or flexure lock, an over-center linkage assembly, or a combination thereof.

Referring now to FIGS. 3A-3C, this example solar panel mounting system can include a panel mount clamp assembly 300 with a panel mount 100 and a torque tube clamp 210. As shown, panel mounts 100A and 100B can include retaining features, which in this instance, are retaining channels 110A and 110B. The panel mounts in this example are both attached to or are both attachable to torque tube clamps 210. Notably, a single panel mount can include multiple retaining features, one for retaining one solar panel 150 and another for retaining another solar panel. In further detail, as shown, a solar panel can be inserted into a first retaining channel 110A and then placed into a second retaining channel 110B of a different panel mount. Note that in this example, the first retaining channel is in the form of a C-channel, with the first retaining channel being defined to include three channel walls, e.g., a lower channel wall oriented orthogonally relative to a rear channel wall and an upper channel wall angled at greater than about 95° relative to the rear channel wall. The second retaining channel, on the other hand, is also a C-channel, but is shallower and its upper channel wall is essentially parallel with its lower channel wall (both being orthogonal relative to its rear channel wall.) In this configuration, the upper channel wall and deeper C-channel are configured to receive a solar panel 150 from overhead at an angle of insertion greater than about 5° relative to the orientation of the first channel wall. In this example, the solar panel is shown as a monolithic structure, but it is understood that the panel shown would typically be a solar panel element mounted on a support rail(s) or a support frame, as shown in FIGS. 2A and 2B, respectively. In this example, when the first and second panel mounts are mounted on a torque tube via the first and second torque tube clamps, respectively, the first retaining feature faces the second retaining feature, and the first and second retaining features are oriented orthogonally relative to the torque tube. Furthermore, in this example, at least one of the first panel mounts or the second panel mount is configured for overhead or lateral insertion of a solar panel while the torque tube clamps are installed on the torque tube. Also shown in this example, the first retaining channel is shown as including a biasing structure 106 to provide outward mechanical pressure against the solar panel, enhancing the fit of the solar panel between the first and second panel mounts. The biasing structure(s) described herein, for example, can be positioned at least partially within a panel support channel and can provide a tightening bias between two adjacent panel supports when a solar panel is installed therebetween. Example biasing structures include a spring, a resilient material, or other spring-like structure. This solar panel mounting system can be modified to be a solar panel alignment system by inclusion of alignment structures and/or use of perception sensors, lasers, or the like, for alignment using an automated panel insertion vehicle, for example.

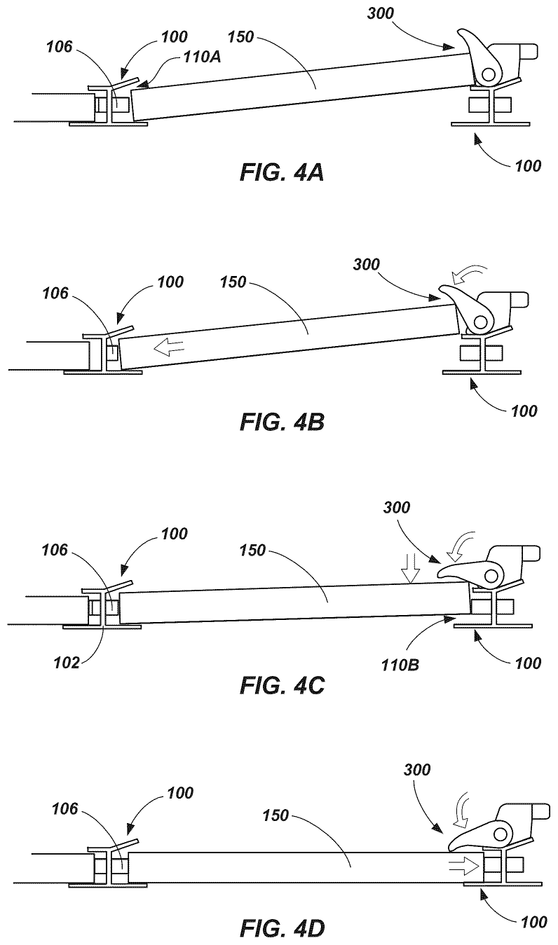

Referring now to FIGS. 4A-4D, an angled overhead insertion of a solar panel 150, similar to that shown in FIGS. 3A-3C, is shown as being installed with the aid of an automation tool 300. Again, in this example, the solar panel is shown as a monolithic structure for simplicity, but it is understood that the solar panel would typically include a solar panel element mounted on a support rail(s) or a support frame, as shown in FIGS. 2A and 2B, respectively. This automation tool shown is the structure that directly interfaces with the solar panel and could be connected to any number of automation assemblies, such as mechanical arms, vehicles, or the like. In this example, the automation tool includes a lever that is initially in an upward or open position so that upon inserting the solar panel into a retaining channel 110A opposite the automation tool, the solar panel can be accommodated next to the automation channel. Then, as the automation tool is rotated as shown in FIGS. 4B and 4C, the other edge of the solar panel may be dropped into retaining channel 110B. As shown, the biasing structures 106 can create some tension between the opposite edges of the solar panel. After the solar panel is fully seated between retaining channels 110A and 110B with the assistance of the biasing structures providing a firm installation, the automation tool may be removed and used to install the next solar panel along the torque tube (not shown).

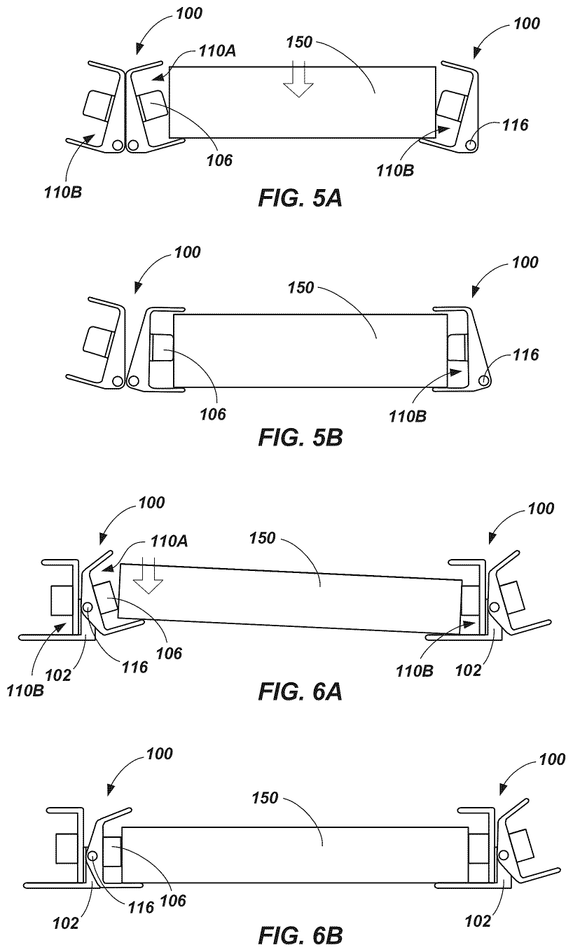

Referring now to FIGS. 5A and 5B, a solar panel mounting system is shown that includes a pair of panel mounts 100A and 100B positioned to receive a solar panel 150 by overhead installation. In this example, because the panel mounts are configured to rotate about a panel mount support pivot 116, the solar panel can be installed directly from above without the need to insert one edge of the solar panel prior to the other edge of the solar panel. Thus, the solar panel can be seated in the first retaining channel 110A and the second retaining channel 110B simultaneously by applying a downward force on the solar panel. Again, in this example, there are biasing structures 106 present to provide a firm fit between the retaining channels. Notably, the individual panel mounts may include both a first and second retaining channel, which are used independently for receiving two adjacent solar panels during installation. This solar panel mounting system can be modified to be a solar panel alignment system by inclusion of alignment structures and/or use of perception sensors, lasers, or the like, for alignment using an automated panel insertion vehicle, for example.

FIGS. 6A and 6B illustrate an example solar panel mounting system similar to that shown at FIGS. 5A and 5B, except that in this instance, panel mount 100A includes a panel mount support pivot 116 and panel mount 100B does not include the pivot. Thus, in this instance, the solar panel can be installed overhead by inserting the solar panel into one of the retaining features (the second retaining feature 110B in this instance), followed by a downward force applied to the solar panel to seat the solar panel at the other edge into the first retaining channel 110A as a result of a pivoting feature associated with the retaining channel. Thus, in accordance with FIGS. 5A-6B, it is noted that the first panel mount, the second panel mount, or both can be pivotable or pivoted to an open orientation (see FIGS. 5A and 6A) to provide clearance for overhead solar panel insertion into the first support channel, the second support channel, or both (depending on which arrangement is used). Upon insertion, the first panel mount, the second panel mount, or both can then be pivoted to a closed orientation upon application of a downward force, such as to the solar panel. Again, in this example, there are biasing structures 106 present to provide a firm fit between the retaining channels. Notably, the individual panel mounts may include both a first and second retaining channel, which are used independently for receiving two adjacent solar panels during installation. This solar panel mounting system can be modified to be a solar panel alignment system by inclusion of alignment structures and/or use of perception sensors, lasers, or the like, for alignment using an automated panel insertion vehicle, for example.

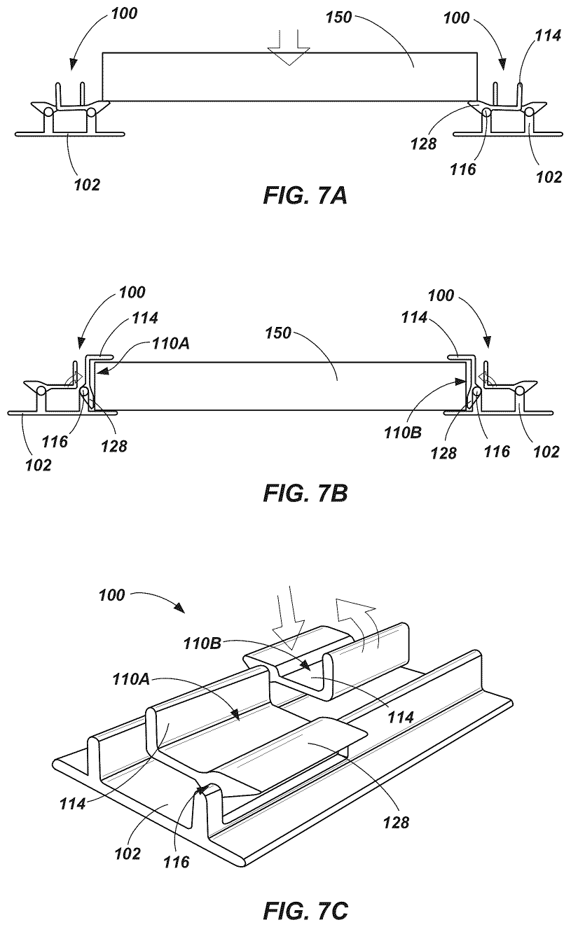

FIGS. 7A-7C illustrate another example solar panel mounting system similar in some ways to that shown at FIGS. 6A-6B, except that in this instance, rather than the use of biasing structures present on the panel mounts 100A and/or 100B, each panel mount includes a lever portion 128 as part of the channel wall that defines the respective retaining channels 110A and 110B. For example, the plan side view of FIG. 7A and the perspective view of FIG. 7C depict the panel mounts in an open orientation, and the plan side view of FIG. 7B depicts the panel mounts in a closed orientation after insertion of the solar pane 150. This is accomplished due to the panel mounts being rotatable about a panel mount support pivot 116. Thus, in this instance, the solar panel can be installed overhead by inserting both sides of the solar panel 150 onto the lever portions of the panel mounts with a downward force, causing the position of the retaining channels to rotate and face opposing edges of the solar panel. In further detail, the lever portion is angled and has a thickness suitable for providing a relatively snug fit when the solar panel is fully seated between the respective retaining channels. In short, the panel mounts shown in FIGS. 7A-7C can be pivotable or pivoted to an open orientation to provide clearance for overhead solar panel insertion into the support channels, and upon insertion, the panel mounts can then be pivoted to a closed orientation upon application of a downward force, such as to the solar panel. This solar panel mounting system can be modified to be a solar panel alignment system by inclusion of alignment structures and/or use of perception sensors, lasers, or the like, for alignment using an automated panel insertion vehicle, for example.

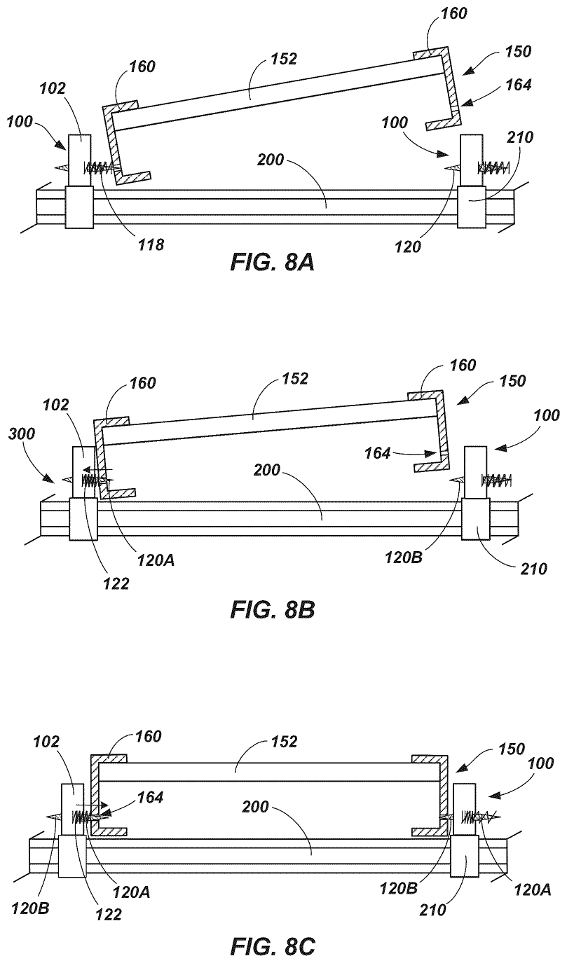

Referring now to FIGS. 8A-8B, another solar panel mounting and alignment system is shown that includes a panel mount clamp assembly 300 with a panel mount 100 and a torque tube clamp 210. This solar panel mounting and alignment system shown may be suitable for angled overhead insertion of a solar panel 150 between two panel mounts 100, each of which is mounted on a torque tube clamp 210, both of which are mounted on a torque tube 200. In this example, the solar panel is shown with its solar panel element 152 supported by a support frame 160, shown in cross-section. One of the panel mounts includes a first (longer) fixed pin 120A associated with a spring 122, and at an adjacently installed panel mount (or on the other side of the same panel mount), the panel mount may be equipped with a second (shorter) fixed pin 120B. Notably, the first pin may be a fixed pin with a different type of biasing structure present along the panel mount, e.g. such as the biasing structure 106 shown in FIGS. 3A. In other words, the spring may or may not be associated directly with the first fixed pin, but may be operationally associated therewith to bias a solar panel being installed toward the second fixed pin. In other words, on one side, there may be a pin and a biasing structure, with the spring positioned about the pin (as shown) or as a separate structure located along a face of the panel mount. Thus, the pin itself may or may not be associated directly with the spring. In this example, the solar panel may be installed first on the longer first fixed pin, and the spring (wherever it is positioned) may provide a biasing or springing force away from that side and toward an adjacently installed panel mount on the other side of the solar panel, which may be equipped with a second fixed pin, for example. In further detail, the panel support frame is equipped with panel support apertures 164 at locations suitable for receiving either the fixed pins upon angled overhead insertion of the solar panel on one side followed by dropping in the other side to align with the panel support apertures. As shown in FIG. 8A, the solar panel is inserted into the panel mount with the first fixed pin. The first fixed pin is shaped so that when the solar panel is at least partially installed via its panel support aperture about the first fixed pin, the spring is depressed into the sufficiently to provide enough clearance for the other panel mount to pass by the fixed pin, as shown in FIG. 8B. The spring force of the spring (or other biasing structure) pressing the solar panel toward the second (shorter) fixed pin allows for both pins (one on each side) to remain seated within their respective panel support apertures, as shown in FIG. 8C. Thus, in this example shown, there may be a first retaining feature in the form of a first fixed pin and a second retaining feature in the form of a second fixed pin that is shorter than the spring-loaded pin. In this example, however, there is another retaining feature in the form of a biasing structure or spring on at least one side. There may also be retaining channels present, which are not shown in this example, but are shown by way of example in FIGS. 3A-3C. It is also noted that although the solar panel is shown as being supported by a support frame, the solar panel could just as likely include support rails (frameless solar panel) with corresponding panel support apertures for overhead insertion of solar panels to engage with the fixed pins, as described above.

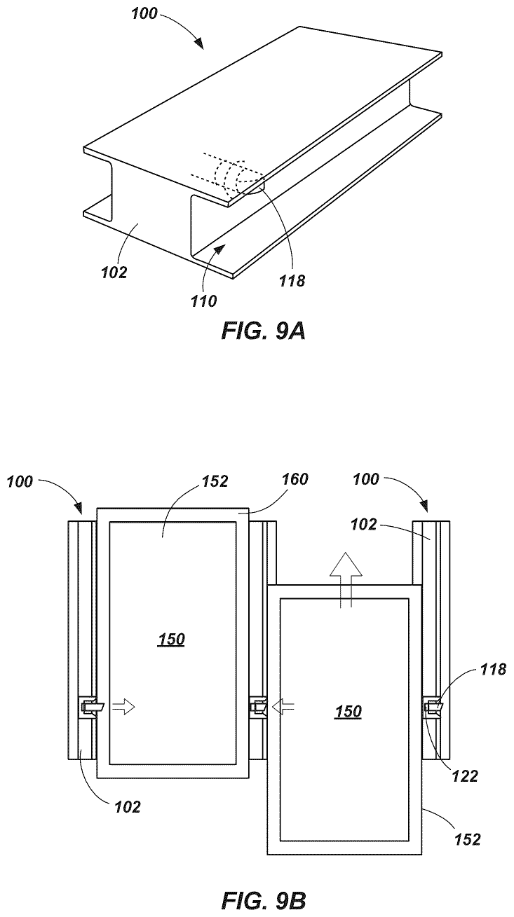

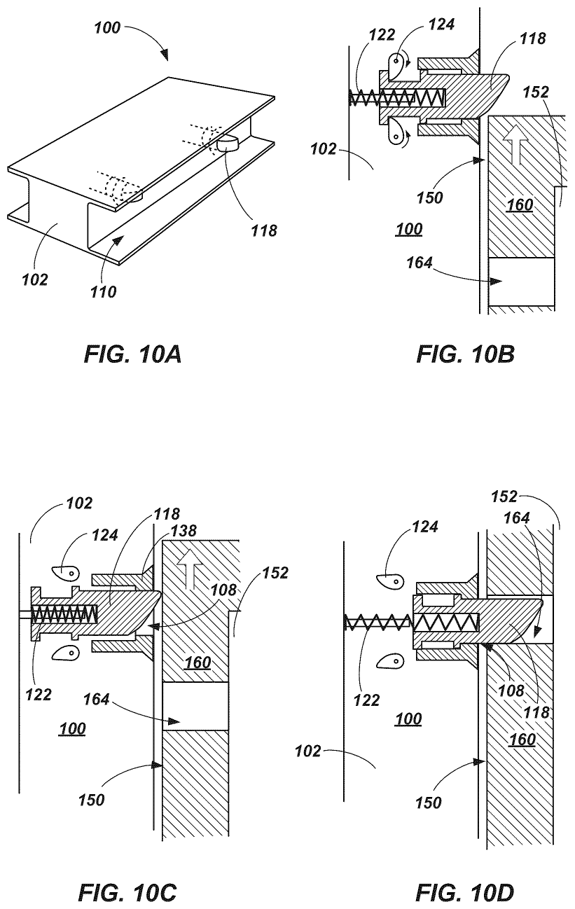

FIGS. 9A and 9B illustrate another example of a panel mount 100 that can be used on one side or both sides of a solar panel 150. In the example shown, the solar panel would have a support frame (not shown), but could likewise be supported by support rails (frameless solar panels) with minor modification of the location of the panel mounts. This example provides for lateral (slidable) insertion of the solar panel 150, e.g., lateral insertion orthogonal to the direction of the torque tube. In this example, the panel mount shown includes multiple retaining features, namely a retaining channel 110 and the inclusion of a spring-loaded pin 118. Additional detail regarding the spring-loaded pin is provided below in the example shown in FIGS. 10A-10D.

Referring now to FIGS. 10A-10D, an example of a panel mount 100 is shown that could be used on one side or both sides of a solar panel (with a support frame or support rails), which may be of particular use for slidable insertion of the solar panel 150, e.g., lateral insertion orthogonal to the direction of the torque tube. In this example, the panel mount shown includes multiple retaining features, namely a retaining channel 110 and the inclusion of spring-loaded pins 118 that can ingress and egress through a panel mount aperture 108. Notably, in this example, spring loaded pins are configured as multi-level engagement pins, meaning that in addition to the configuration where there is no elevation or engagement, e.g., completely retracted or recessed, there are multiple protruding pin elevations for engaging with the solar panel (support frame or support rail). Examples include an initial mid-level engagement elevation (See FIG. 10A), followed by a recessed elevation (See FIG. 10B) that occurs during slidable insertion of the solar panel, followed by an extended engagement elevation (See FIG. 10C) when a panel support aperture 164 of a support frame or support rail of the solar panel becomes aligned with the multi-level engagement pin, thereby allowing the multi-level engagement pin to become seated in the panel support aperture at the extended elevation. In this example, the spring-loaded pin has multiple levels of engagement with the solar panel (as well as non-engagement or full retraction) due to the presence of a spring 122, a pin-retaining feature 138, and a pin lever mechanism 124 that work together to provide the multiple elevations prior to engagement with the solar panel and then after engagement with a panel support aperture of the solar panel. As shown in FIG. 10B, prior to engagement with the solar panel, the spring-loaded pin is at its initial position, biased partially inward and held in place by the pin lever mechanism. Upon engagement with the solar panel during a slidable insertion event, as shown in FIG. 10C, the pin lever mechanism rotates out of the way. The pin lever mechanism may likewise be spring-loaded, for example. As shown in FIG. 10D, when the panel support aperture is aligned with the spring-loaded pin, the pin can become seated in the panel support aperture at its extended engagement elevation.

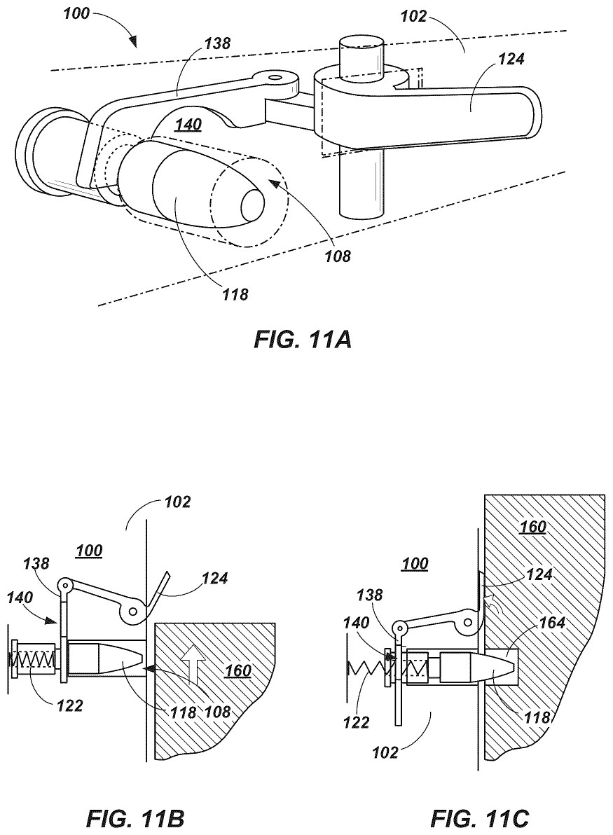

Referring now to FIGS. 11A-11C, another example panel mount 100 is shown that could be used on one side or both sides of a solar panel 150, which may be of particular use for slidable insertion of the solar panel 150, e.g., lateral insertion orthogonal to the direction of the torque tube. More specifically, FIG. 11A illustrates a perspective view of the panel mount with a spring-loaded pin 118 and a pin lever mechanism 124, FIG. 11B depicts a side plan view of the panel mount before it engages with the solar panel, and FIG. 11C depicts a side plan view of the panel mount after it engages with the solar panel. More specifically, as shown in FIGS. 11A-11C, the panel mount includes a spring-loaded pin that is biased outward, but in this instance, rather than the spring-loaded pin engaging with the solar panel as it is slidably installed, the feature that engages with the solar panel is a pin lever mechanism. The pin lever mechanism is operationally attached to a pin-retaining feature 138 that prevents the pin from protruding through a panel mount aperture 108 until the pin lever mechanism is depressed by the solar panel as it is slid past the pin lever mechanism. In this example, the pin-retaining feature has a pin-retaining feature recess 140 that allows the pin to freely pass through consistent with the bias provided by spring 122. As the spring-loaded pin is biased outward, when the pin-retaining feature recess is aligned therewith, the spring-loaded pin can enter the panel support aperture 164 when it is slid in place in alignment with the spring-loaded pin.

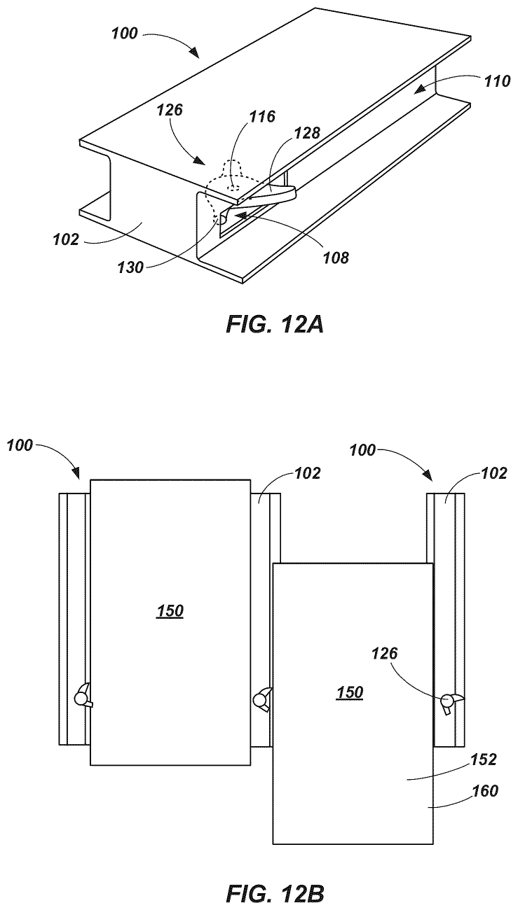

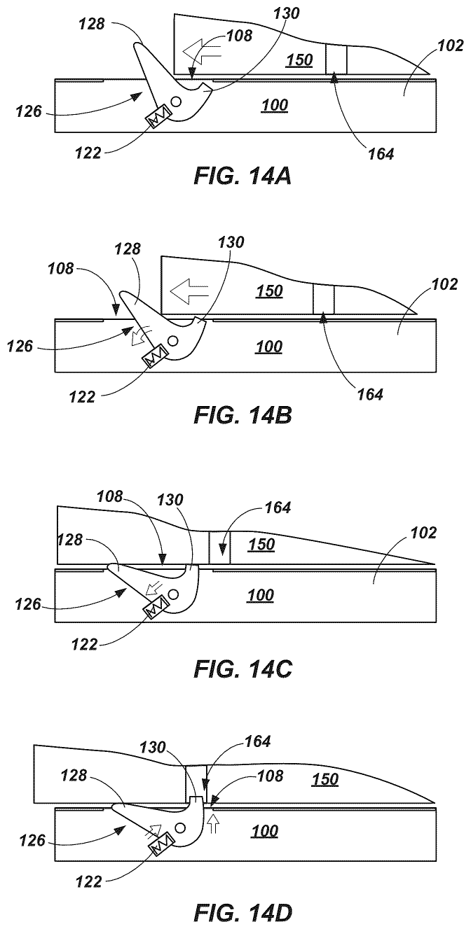

Referring now to FIGS. 12A and 12B, a perspective view of a panel mount 100 (FIG. 12A) and a top plan view of multiple panel mounts as they are engaged or are slidably engaging with solar panels 150 are shown. This particular panel mount includes two retaining features, namely a retaining channel 110, and a rotatable levered pin 126, portions of which can protrude and retract through a panel mount aperture 108. In this example, the rotatable levered pin includes a lever portion 128 that interfaces with the solar panel as it is inserted laterally through the retaining channel. The panel support (not shown, but could be either a support frame or a support rail, as shown in FIGS. 2A and 2B at 160 and 162, respectively) may include corresponding panel support apertures (not shown, but shown by example in FIGS. 10C and 10D at 164) that when aligned with a pin portion 130 of the rotatable levered pin, the solar can be held in place by this engagement. The rotatable levered pin, for example, may be spring-biased in a manner similar to that shown in FIGS. 14A-14D hereafter.

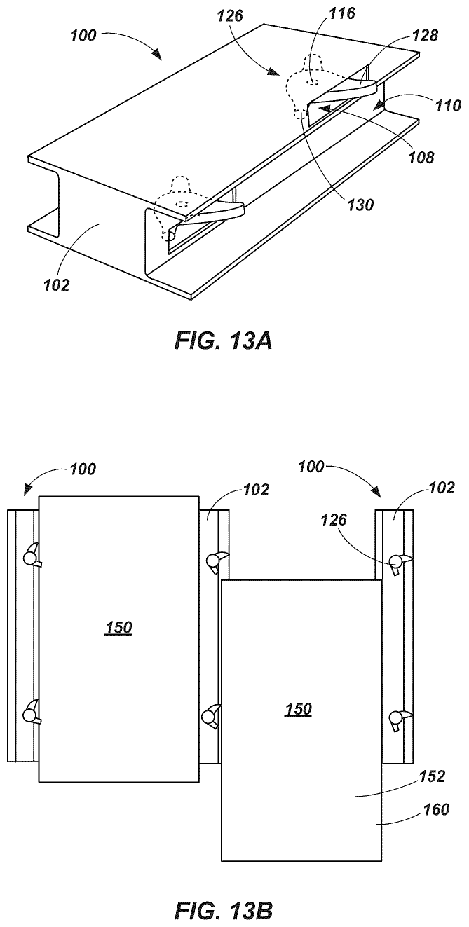

Referring now to FIGS. 13A and 13B, a similar arrangement to that shown in FIGS. 12A and 12B is provided, except that rather than two retaining features, namely the retaining channel 110 and the rotatable levered pin 126 positioned at a panel mount aperture 108, there is a third retaining feature, which is a second rotatable levered pin associate with its own panel mount aperture. The structures in this example for the second rotatable levered pin may be the same or similar to that of the (first) rotatable levered pin. Again, the panel support (not shown, but could be either a support frame or a support rail, as shown in FIGS. 2A-2B) may include corresponding panel support apertures (not shown, but shown at FIG. 10C and 10D at 164 by way of example) that when aligned with a pin portion 130 of the multiple rotatable levered pin, the solar can be held in place by these engagements, e.g., placement within the retaining channel with multiple engagements with the multiple rotatable levered pins.

Referring now to FIGS. 14A-14D, a side cutaway view of a portion of a solar panel mounting and alignment system is shown, which includes a panel mount 100 with a retaining feature embedded therein, which in this instance is a rotatable levered pin 126, portions of which can protrude and retract through a panel mount aperture 108. More specifically, FIG. 14A shows a side cutaway view of a rotatable levered pin prior to contact with the solar panel 150, FIG. 14B illustrates the rotation of the rotatable levered pin beginning upon solar panel contact during lateral (slidable) insertion, FIG. 14C illustrates the rotatable levered pin in position to allow the solar panel to pass by, and FIG. 14D illustrates the rotatable levered pin after its pin portion 130 becomes seated within a panel support aperture 164 of the support frame or support rails (not shown, but shown at 160 and 162, respectively). Thus, the rotatable levered pin includes a lever portion 128 that engages with the solar panel as it slides along a surface of the panel mount. When a pin portion becomes aligned with the panel support aperture, the pin portion enters the panel support aperture of a panel support. In this particular example, the rotatable levered pin can be spring loaded with spring 122. Thus, FIGS. 14A-14D sequentially illustrate how engagement of the solar panel with the rotatable levered pin causes the pin portion to ultimately become engaged with the panel support aperture (see FIG. 14D) to lock the solar panel in place laterally. Note that in the examples shown in FIGS. 13A-14D, the pin portion and the lever portion are located on a common rotatable levered pin.

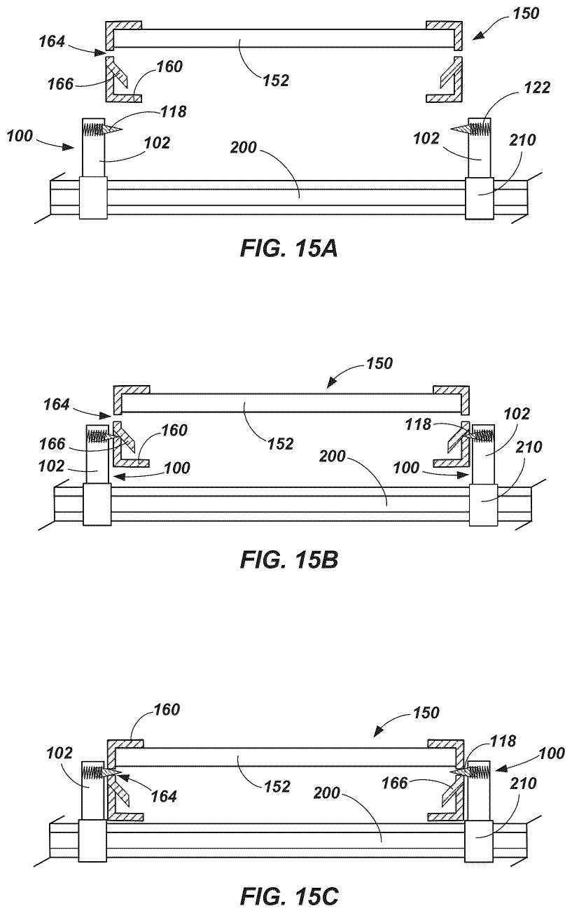

Referring now to FIGS. 15A-15C, another panel mount clamp assembly 300, including a panel mount 100 and a torque tube clamp 210, is shown as part of a solar panel mounting and alignment system that is suitable for overhead insertion of a solar panel 150 between two panel mounts, each of which is mounted on a torque tube clamp with both torque tube clamps mounted on a torque tube 200. In this example, the solar panel includes a solar panel element 152 supported by a support frame 160, shown in cross-section. Both of the panel mounts include spring-loaded pins 118, which are each retractable into its respective panel mount. The panel support frame is equipped with panel support apertures 164 at locations suitable for receiving the spring-loaded pins upon overhead insertion of the solar panel. Unlike the example shown in FIGS. 8A-8C, the overhead installation does not require an angled overhead insertion of one side followed by the other side. This is because the support frame in this example includes an angled retractor feature 166 that acts to retract the spring-loaded pin that it engages with (see FIG. 15B) until the support frame is slid down far enough to align the panel support aperture with the spring-loaded pin. Thus, once the solar panel is seated (above the torque tube and between the panel mounts), the spring 122 of the spring-loaded pin can release, seating the fixed pin in its corresponding aperture, as shown in FIG. 15C. As with other examples, it is noted that although the solar panel is shown as being supported by a support frame, the solar panel could just as likely include support rails (frameless solar panel) with corresponding panel support apertures for overhead insertion of the spring-loaded pin and the fixed pin therein. Thus, in this example, there may be a first and second retaining feature, each of which includes a spring-loaded pin. The support frame or support rails of the solar panel include one or more angled retraction features to cause the spring-loaded pins to retract into the first retaining feature, the second retaining feature, or both upon overhead insertion of the solar panel. The support frame or support rails of the solar panel in this example include a plurality of panel support apertures to permit the spring-loaded pin to release from being retracted to become seated in the panel support apertures.

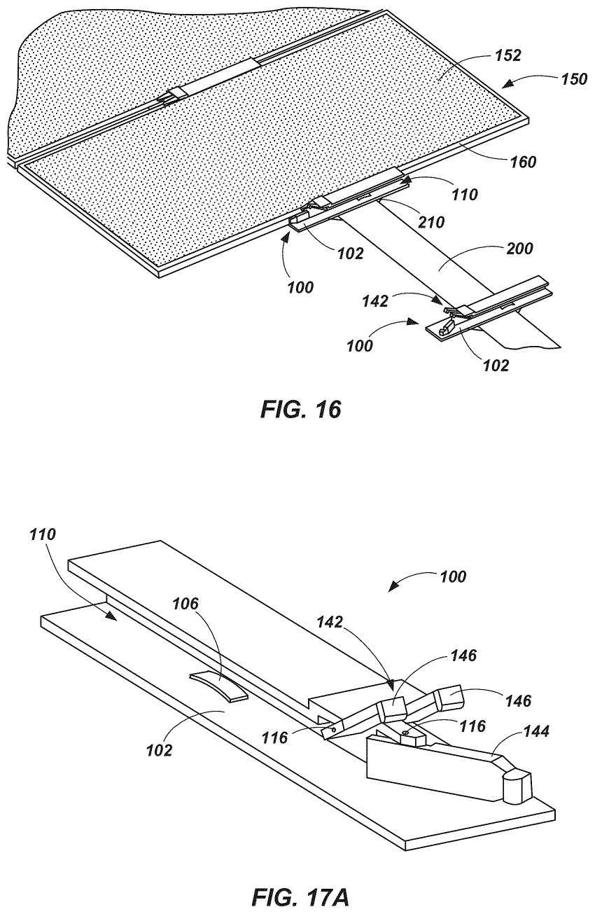

Referring now to FIG. 16, a panel mount clamp assembly 300, including a panel mount 100 and a torque tube clamp 210, is shown with a perspective view of a series of solar panels 150 being installed in a direction parallel with a torque tube 200 is shown. The panel mounts shown may be coupled with the torque tube using a torque tube clamp (not shown as being obscured by the panel mounts, but an example of a torque tube clamp is shown at 210 in FIGS. 3A-3C). In this example, the panel mounts are equipped with multiple retaining features, including lead-in latch assemblies 142 that are suitable for lateral (sliding) insertion of solar panels into the panel mounts in accordance with the present disclosure. The lead-in latch assemblies are mounted on a panel mount support. An additional retaining feature includes a retaining channel 110. Thus, a properly spaced adjacent pair of panel mounts are in position to receive and retain a solar panel therebetween within the retaining channels, and furthermore, may be locked into place with additional security using the lead-in latch assemblies.

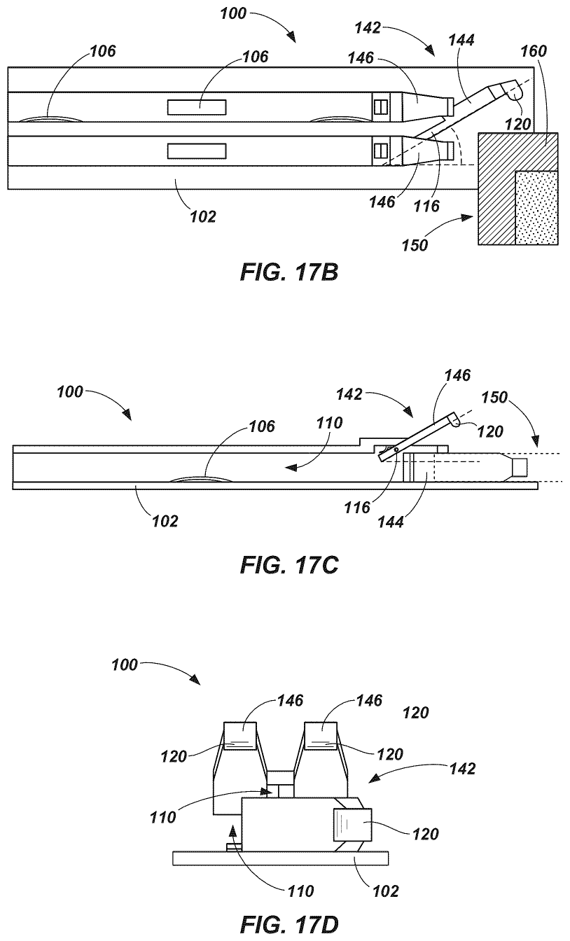

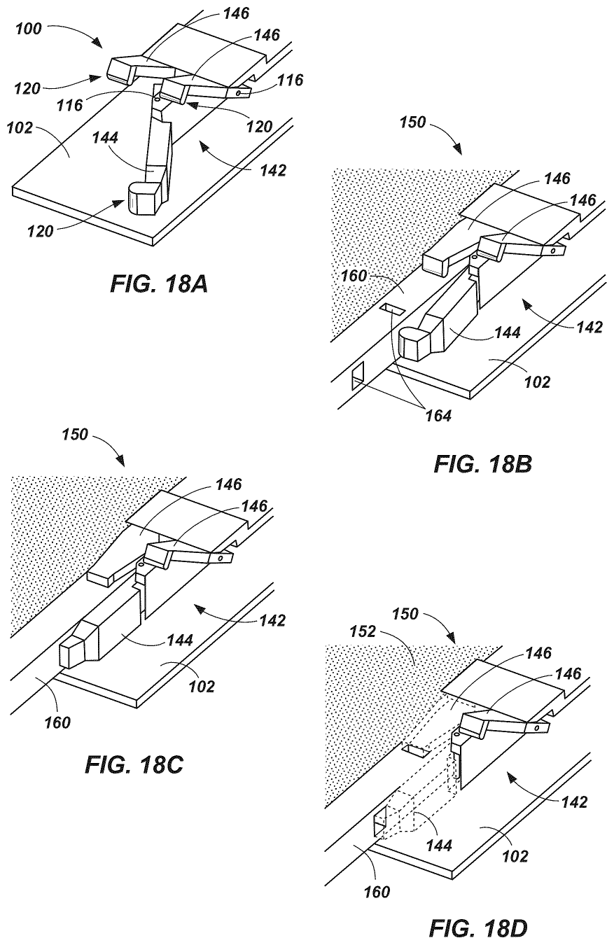

A more detailed view of a panel mount 100 is shown in FIGS. 17A-17D by way of example. FIG. 17A provides a perspective view of the panel mount, FIG. 17B illustrates a top plan view of the panel mount as the solar panel 150 is being slidably inserted, FIG. 17C illustrates a side plan view of the panel mount as the solar panel is being slidably inserted, and FIG. 17D provides an end view of the panel mount to show the elevations of the various retaining features. As mentioned in FIG. 16, the retaining features of this example include a lead-in latch assembly 142. In greater detail, the assemblies can include an edge lead-in latch 144 to engage with panel support apertures (not shown, but shown in FIGS. 18A-18D hereinafter) positioned along an edge of a support frame 160 of the solar panel or along an edge of a support rail (not shown) and two facial lead-in latches 146 to engage with panel support apertures (not shown, but shown in FIGS. 18A-18D hereinafter) positioned along a facial surface (the planar surface) of the support frame (not shown). Notably, one of the facial lead-in latches is used at the opposite edge of the next solar panel to be installed. This example also includes another type of retaining feature, namely a retaining channel 110 that is equipped with biasing structures 106 to provide a snug fit to the solar panel while being laterally (slidably) inserted and also a snug fit after full insertion into the panel mount. Furthermore, both the edge lead-in latch and the facial lead-in latches are positioned on the panel mount support 102 individually via a panel mount support pivot 116 such that when the solar panel is slid into place, a lever arm protruding into the retaining channel is engaged, and by lever action, an engagement protrusion 120 (which operates similar to a pin for engagement with a panel support aperture described previously) on the lever arms pivots toward the support frame (or support rail) to engage with the panel support apertures.

The term “lead-in latch” refers to a latch that includes a portion that interacts by pivoting or being deformed to receive a solar panel due to mechanical interaction with an edge or face of a solar panel frame or an edge or face of a solar panel rail. The lead-in latch can then at least partially pivot back or return from its deformed configuration, such as when the latch reaches a location along the solar panel frame, e.g., a panel support aperture or detent, where the solar panel can be locked into place by a latch protrusion, process, or pin. The lead-in latch assemblies can be mounted on a panel mount support. An additional retaining feature includes a retaining channel 110. Thus, a properly spaced adjacent pair of panel mounts are in position to receive and retain a solar panel therebetween within the retaining channels, and furthermore, may be locked into place with additional security using the lead-in latch assemblies.

FIGS. 18A-18D illustrate an example sequence of operation of a panel mount with the lead-in latch assembly described in FIGS. 23-17D above. More specifically, FIG. 18A illustrates a panel mount 100 including a panel mount support 102 connected to three lever arms via panel mount support pivots 116 as the retaining features, which include an edge lead-in latch 144 and two facial lead-in latches 146 as part of a lead-in latch assembly 142. Each of the lead-in latches is equipped with an engagement protrusion 120 that will align with various panel support apertures 164 when the solar panel is slid into place through the retaining channel 110.

FIG. 18B, in particular illustrates the edge lead-in latch 144 and one of the facial lead-in latches 146 being partially actuated as the support frame 160 of the solar panel 150 slides through the retaining channel (not shown, but shown in FIG. 17D at 110). Since the panel support apertures 164 have not reached the engagement protrusions 120 at this point during solar panel insertion, the engagement protrusions slide along the two support frame surfaces shown, generating some pressure against these two support frame surfaces as well as against the panel mount support.

FIG. 18C illustrates the solar panel 150 once the engagement protrusions 120 of the edge lead-in latch 144 and one of the facial lead-in latches 146 reaches their respective panel support apertures 164. Once the engagement protrusions drop into two panel support apertures due to pressure being relieved by the support frame 160 (or support rail, not shown), the solar panel becomes locked in place along two different orthogonal surfaces of the support frame, generating a secure and stationary installation.

FIG. 18D also illustrates the solar panel 150 locked in place along its support frame 160, but in this example, the other of the facial lead-in latches 146 that is still in its unengaged position is ready to accept the next solar panel to be installed. Notably, on this (second) side of the panel mount, there is not an edge lead-in latch, but there could be with a little bit more separation between adjacently installed solar panels. However, with this configuration, if an identical or similar panel mount is installed along the torque tube at a distance suitable for installation of another solar panel, then the other side of the next solar panel installed would likewise benefit from engagement of both an edge lead-in latch 144 and a facial lead-in latch 146 with the support frame at its panel support apertures. Thus, on one side of each panel, the lead-in latch assembly 142 would engage with the support frame at two panel support apertures and on the other side of each panel, the lead-in latch assembly 142 would engage with the support frame at one panel support aperture. Stated another way, each panel mount shown in this example includes a first side with two lead-in latches, e.g., an “edge” lead-in latch and a “facial” lead-in latch, and a second side of each panel mount includes one lead-in latch, e.g., a “facial” lead-in latch (for receiving one side of an adjacent solar panel).

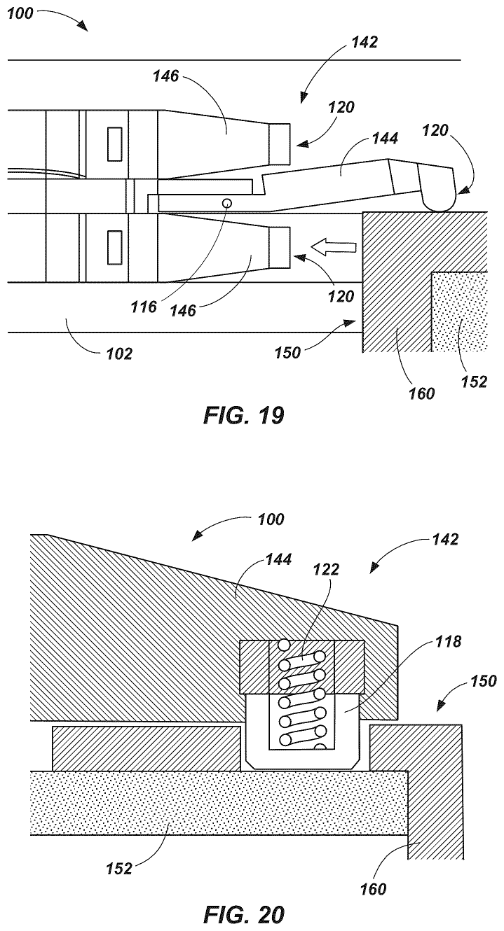

Referring now to FIG. 19, an alternative example panel mount with a lead-in latch assembly 142 is shown where the edge lead-in latch 144 and the facial lead-in latches 146 deform elastically. Thus, a panel mount support pivot may or may not present in this example, as the material of lead-in latches may provide enough resilient elasticity to deflect while inserting the solar panel 150. However, in some examples, the panel mount support pivot 116 (or ground pivot) may still be present to provide a force on the opposite side of the pivot to push the latch into the panel support aperture. In this latter instance, the elastic deformation enables the latch slightly deform to slide along the panel until the aperture is reached. The pivot may also enable a greater degree of rotation for a larger lead-in distance, in some examples. The lead-in latches include lever arm portions that include the engagement protrusion 120 available to deflection, while the balance of the structures or the pivots are fixedly attached to the panel mount support 102, and then returned to a position suitable for becoming seated within the panel support apertures (not shown, but shown in FIG. 18B) when the panel is aligned in the correct position.

FIG. 20 illustrates a portion of an example panel mount 100 with an edge lead-in latch 144 that includes a spring-loaded engagement protrusion 118 with an internally positioned spring 122. In some examples, there may or may not be a panel mount support pivot (not shown, but shown by way of example at 116 in FIG. 19) for providing a lever mechanism. The edge lead-in latch may be of rigid material or may be of a material that deforms elastically, as described also in FIG. 19). However, the engagement protrusion in this instance is in the form of a spring-loaded pin 118. In instances where there is a panel mount support pivot (or ground pivot), the pivot may provide a force on the opposite side of the pivot to push the spring-loaded pin of the lead-in latch into the panel support aperture. In some examples where the lead-in latch is equipped with elastic deformation, this will enable the lead-in latch to slightly deform (along with the spring-loaded pin being retracted) to slide along the panel until the panel support aperture is reached. Thus, some of the retraction can occur via the lead-in latch deformation and some can occur via the spring-loaded pin retraction. Either way, the spring-loaded pin can should be able to retract and/or deflect sufficiently to slide along the latch support frame (or support rail) until the panel support aperture is reached. The pivot may also enable a greater degree of rotation for a larger lead-in distance, in some examples. Any combination of these three embodiments may be used together, or each may be used separately (as shown). Likewise, these examples that utilize a lead-in latch mechanism to engage with panel support apertures may engage with a support frame 160 (supporting the solar panel element 152) of the solar panel 150 as shown in FIGS. 23-27, or may alternatively engage with support rails (not shown) of a frameless solar panel.

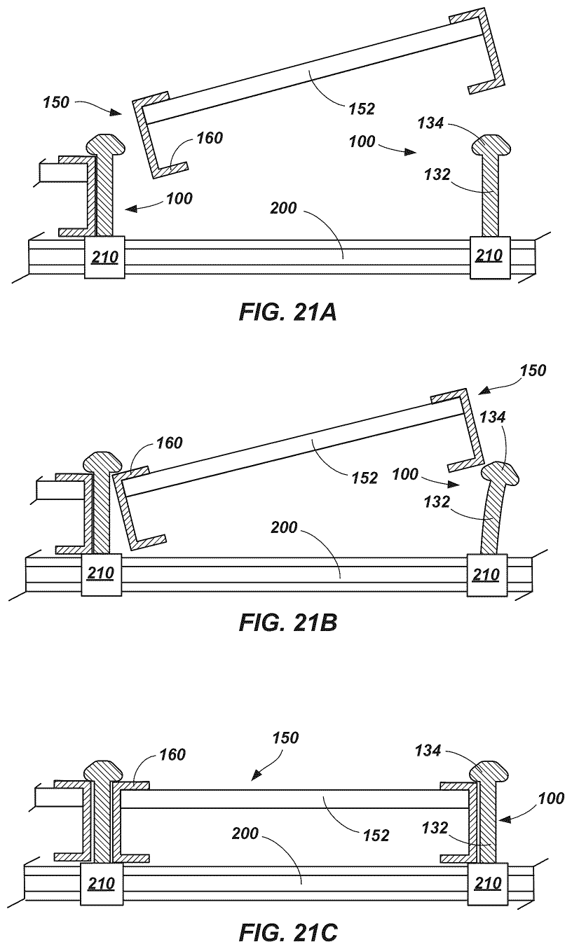

Referring now to FIGS. 21A-21C, another example panel mount clamp assembly 300, including a panel mount 100 and a torque tube clamp 210, is shown as part of a solar panel mounting and alignment system is shown. In this example, the panel mount includes flexible features to allow for overhead insertion of the solar panel 150. As with the other example, the solar panel may include a solar panel element 152 mounted on a panel support, which in this instance is a support frame 160, but could be support rails 162 in the case of a frameless solar panel. The flexible features in this example may include a retaining feature with a flexible structure or portion 132 and a retaining button 134. The retaining features in this example are attached to torque tube clamps, which are mounted on a torque tube 200. In the example shown in FIG. 21A, a previously installed solar panel is present, which is pressed firmly up against one of the panel mounts, preventing the immediately adjacent panel mount from flexing in a direction toward the previously installed solar panel. Thus, when installing the next solar panel from above, the solar panel may be inserted at a slight angle into one of the panel mounts, as shown in FIG. 21B, and the other panel mount can be flexed in an outward direction relative to the solar panel to allow for insertion of the other side of the solar panel, as shown in FIG. 21C. However, it is noted that the solar panel could likewise be installed directly from above (or flat installation) at no angle, simultaneously instilling the panel between the two flexible features of the panel mounts simultaneously. Notably, with the prior solar panel already in place, when installing directly downward without the angle, most or all of the deflection would occur at the panel mount that does not already have a solar panel installed. Once the solar panel is installed between both panel mounts, the next solar panel may be installed (not shown). Thus, in the example shown, a first retaining feature, a second retaining feature, or both may be flexible and include a retaining button 134 positioned to receive and retain a support frame or a support rail of a solar panel. The retaining button can be positioned to retain the support frame 160 above the solar panel 150, as shown in FIGS. 21A-21C. This solar panel mounting system can be modified to be a solar panel alignment system by inclusion of alignment structures and/or use of perception sensors, lasers, or the like, for alignment using an automated panel insertion vehicle, for example.

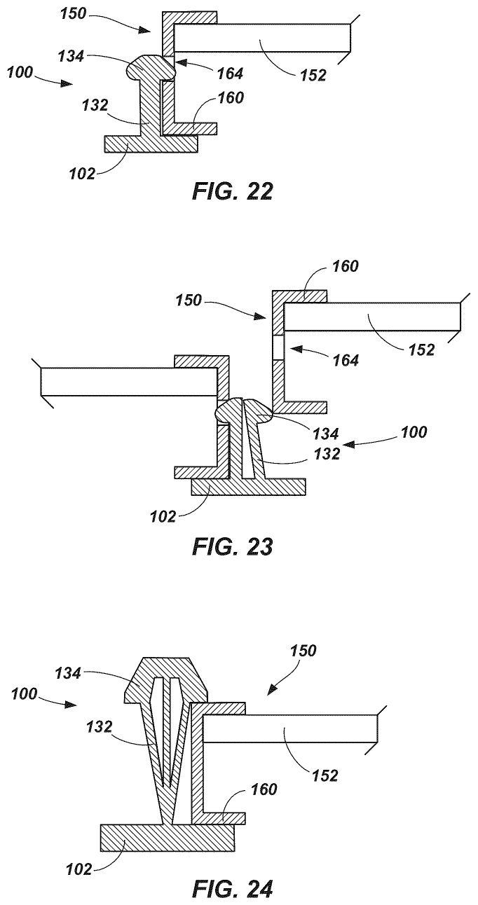

In other examples, the retaining button 134 may be positioned to retain the support frame 160 (or support rails, not shown) at a panel support aperture 164 along a side surface of the solar panel 150, such as that shown in FIGS. 22 and 23. FIG. 22 is the same as that shown in FIGS. 21A-21C, except that the retaining feature is at a lower elevation to engage with the panel support aperture rather than the top of the support frame. FIG. 23, on the other hand, separates two different retaining features on a common panel mount, thus allowing both retaining features to flex independently. This arrangement is suitable for flat overhead installation or angled overhead insertion. In another example, FIG. 24 is arranged similar to that shown in FIGS. 21A-21C, except that this design allows the panel mount a degree of side to side deflection or even to “bow” inward to account for tolerances when installing overhead. Each of these example panel mounts 100 include reference numbers that correspond to those set forth in FIGS. 21A-21C and elsewhere herein. These solar panel mounting systems can be modified to be a solar panel alignment system by inclusion of alignment structures and/or use of perception sensors, lasers, or the like, for alignment using an automated panel insertion vehicle, for example.

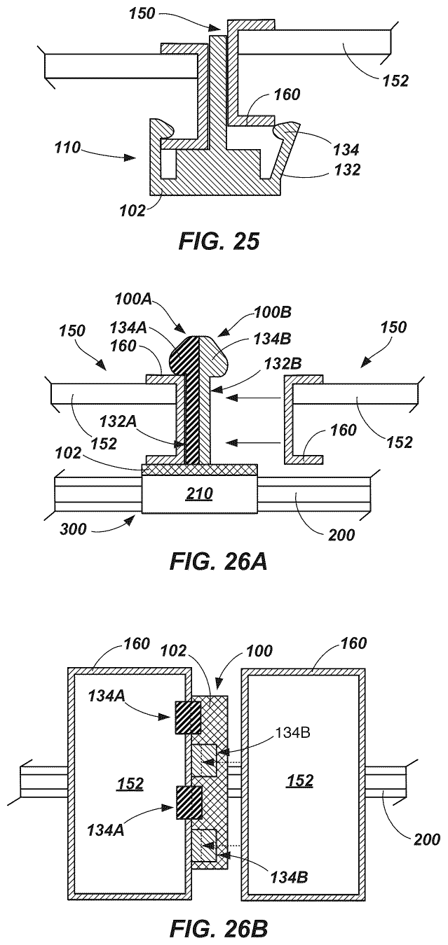

FIG. 25, as shown, illustrates an example solar panel mounting system similar to that shown in FIG. 23, except that rather than being configured to engage with the top of the support frame 160 above the solar panel 150, it allows for engagement with a bottom portion of the support frame or even a similar feature that may be present beneath a support rail (not shown) of a frameless solar panel. As shown, the panel mount is suitable for engagement with two adjacent solar panels, with a first and a second retaining feature, each including a flexible structure or portion 132 and a retaining button 134. This solar panel mounting system can be modified to be a solar panel alignment system by inclusion of alignment structures and/or use of perception sensors, lasers, or the like, for alignment using an automated panel insertion vehicle, for example.

Referring now to FIGS. 26A and 26B, a solar panel mounting system is shown that includes a panel mount clamp assembly 300 with a panel mount 100 and a torque tube clamp 210. The panel mount includes multiple retaining features that are laterally offset in a direction orthogonal with the torque tube 200 when attached thereto via a torque tube clamp 210. FIG. 26A illustrates a side plan view of one solar panel 150 in place and a second solar panel being inserted. Again, in this example, the solar panel includes a solar panel element 152 and a support frame 160 but could alternatively include support rails instead. This arrangement allows for installing solar panels in closer proximity with one another, e.g., smaller gap between adjacent solar panels. The panel mounts in this example include retaining features in the form of flexible structures or portions 132A and 132B which support retaining buttons 134A and 134B. Installation may be carried out by overhead insertion of the solar panels with a downward or orthogonal force relative to the upper planar surface of the solar panel. In further detail and as mentioned, the panel mount is shown as being attached to a torque tube clamp to form the torque tube clamp assembly. The torque tube clamp portion can be in the configuration of any of the torque tube clamps illustrated and described herein. The torque tube 200 shown in this example is an octagon-shaped torque tube (octagon shape in cross-section), but could be any of the shapes described herein, including square, round, or other geometric shape. This solar panel mounting system can be modified to be a solar panel alignment system by inclusion of alignment structures and/or use of perception sensors, lasers, or the like, for alignment using an automated panel insertion vehicle, for example.

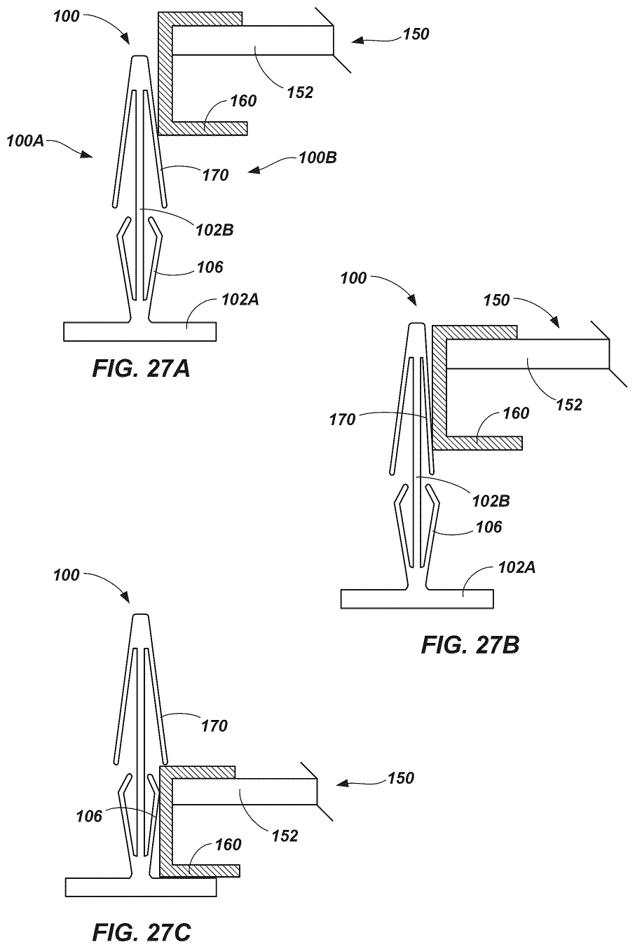

FIGS. 27A-27C illustrate another example of a flexible panel mount 100 at various stages of insertion of a solar panel 150. As shown, the solar panel includes a support frame 160 and a solar panel element 152. FIG. 27A in particular illustrates one side of the solar panel prior to being inserted between two panel mounts (the panel mount on the opposite side of the solar panel is not shown). The panel mount includes a panel mount support 102, which includes a support base 102A and a support column 102B. The panel mount includes two different types of flexible structures, namely a flexure lock 170 and a biasing structure 106. The panel mount includes similar structures on both sides, each side for engaging adjacently installed solar panels. As with many of the other FIGS., only one side of the panel mount is depicted as being engaged, as the solar panels would typically be installed sequentially.

FIG. 27B illustrates the panel mount 100 as the solar panel 150 is being installed using overhead insertion, which may be by a flat or direct overhead insertion (as shown) or may be an angled overhead insertion (not shown, but shown by way of example at FIGS. 21A-21C, for example). As the solar panel is being installed between the solar panel mounts by a downward force (relative to the support base 102A), the flexure lock 170 becomes depressed, which may create some tension against the edge of the solar panel frame 160 while the solar panel is being installed between two adjacently installed panel mounts.

FIG. 27C illustrates the panel mount 100 once the solar panel 150 has been fully seated between two adjacent panel mounts, with a biasing structure 106 being depressed to provide some tension against the solar panel frame 160. The biasing structure in this example is also a flexure element, which includes an arrowhead configuration so that compression can be controlled when the biasing structure becomes abutted against the support column 102B of the panel mount support 102. When fully seated, the flexure lock is allowed to return to its prior non-retracted position, thus locking the solar panel frame into place with vertical retention (relative to the support base 102A) against the support base. With a similar panel mount positioned on the other side of the solar panel, the biasing structure (or arrowhead flexure) provides a mechanism for horizontal centering of the solar panel between the adjacent panel mounts. This solar panel mounting system can be modified to be a solar panel alignment system by inclusion of alignment structures and/or use of perception sensors, lasers, or the like, for alignment using an automated panel insertion vehicle, for example.

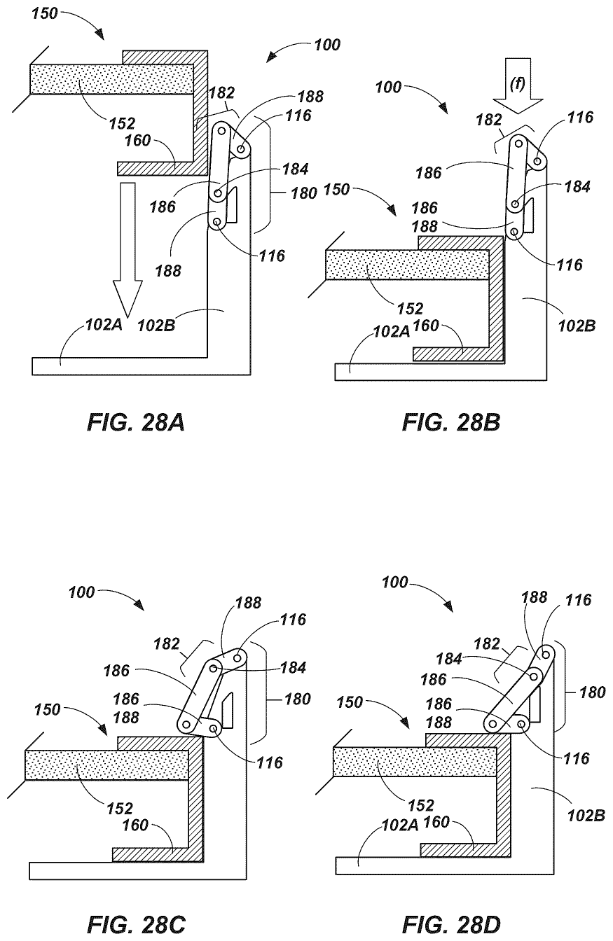

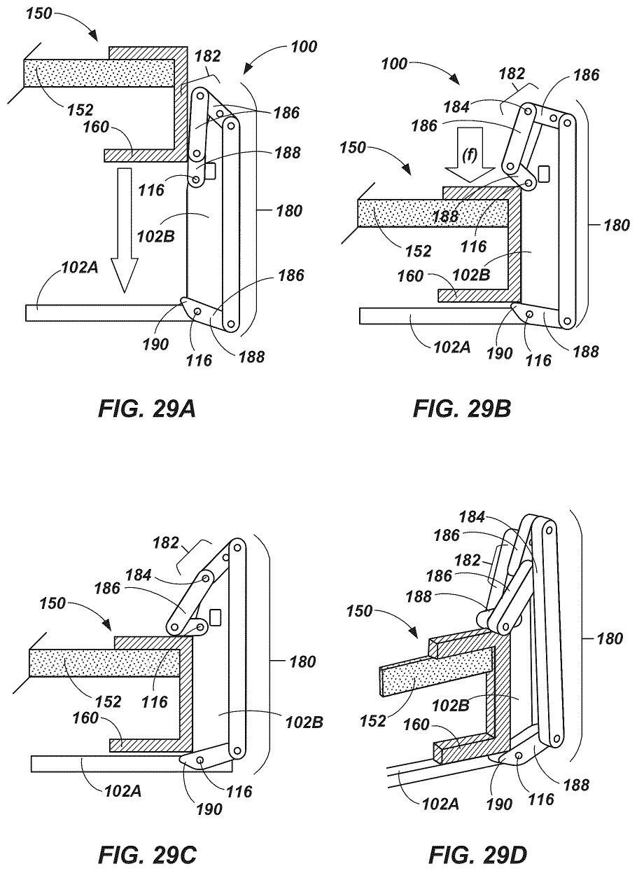

Referring now to FIGS. 28A-28D and FIGS. 29A-29D, two alternative panel mounts 100 are shown that utilize an over-center linkage assembly 180 as a retaining feature to lock solar panel 150 in place. The solar panel is shown with a solar panel element 152 and a support frame 160. The over-center linkage assemblies of both examples include multiple panel mount support pivots 116 (or ground pivots) coupling opposite ends of the over-center linkage assemblies to a panel mount support, which includes a support base 102A and a support column 102B, as well as an over-center linkage with an over-center pivot 184. It is appreciated that though this panel mount support only shows one side of the panel mount, this panel mount could likewise be bi-directional to provide a locking mechanism to another solar panel being installed adjacent to the solar panel using the same panel mount. Additionally, as with many of the other FIGS., only one side of the solar panel is depicted as being engaged, and an adjacently positioned panel mount positioned along the torque tube (not shown) via a torque tube clamp (not shown) at a distance of about a panel width from the panel mount shown is shown.

Regarding FIGS. 28A-28D in particular, the panel mount 100 includes two panel mount support pivots, or ground pivots 116 being attached to a support column 102B of the panel mount support 102. The ground pivots provide for rotational movement to respective ground bars 188. The term “ground” in this instance refers to the pivots and bars that are coupled directly to the panel mount support, which are the structures that ground the balance of the over center linkage assembly to the panel mount support. FIG. 28A in particular illustrates one side of the solar panel 150 prior to being inserted between two panel mounts (the panel mount on the opposite side of the solar panel is not shown). Thus, the over-center linkage assembly is configured to receive the solar panel by overhead insertion, which may be a flat or direct overhead insertion (as shown) or may be an angled overhead insertion (not shown, but shown by way of example at FIG. 3A-4D and/or FIGS. 6A-6B). Notably, as there are three links or bars in this example, it is notable that two of the bars are part of the over-center linkage 182 and one of those two bars is attached to a ground pivot 116 of a ground linkage, which includes a ground bar 188. Thus, the ground bar (labeled both as 186 and 188) is also an over-center bar associated with the over-center linkage in this instance. FIG. 28B illustrates the solar panel after it has been dropped into place being supported below by the support base 102A. In this position, the solar panel is in position to be locked into place. FIG. 29C illustrates the latching force (f) that may be applied to the over-center linkage 182 at about the over-center pivot joint 184, such that when two over-center bars 186 attached to the over-center pivot joint are rotated beyond alignment, one or both of the over-center bars come to rest against the panel support column. In this example, there are three bars or links, with a third bar providing the interface with the solar panel to lock the solar panel between the over-center linkage assembly and the support base of the panel mount support, as shown in FIG. 28D.

Regarding FIGS. 29A-29D in particular, the panel mount 100 also includes two panel mount support pivots 116 (ground pivots), however one of the panel mount support pivots is attached to the support column 102B and the other is attached to the support base 102A of the panel mount support 102. Additionally, rather than only three bars or links, this example includes five bars or links. FIG. 29A in particular illustrates one side of the solar panel 150 prior to being inserted between two panel mounts (the panel mount on the opposite side of the solar panel is not shown). Thus, the over-center linkage assembly is configured to receive the solar panel by overhead insertion, which may be a flat or direct overhead insertion (as shown) or may be an angled overhead insertion (not shown, but shown by way of example at FIG. 3A-4D and/or FIGS. 6A-6B). Rather than the solar panel being supported from beneath directly by the support base, instead one of the ground pivots 116 associated with the support base includes an extended lever arm 190 which contacts the lower facial surface of the solar panel frame 160. Thus, at this point, the solar panel is not resting directly on the support base. FIG. 29B illustrates a first rotational movement of over-center linkage assembly 180 that occurs to put the over-center linkage assembly in position for locking the solar panel in place. That first rotational movement occurs as the solar panel is pressed downward against the extended lever arm using a first force (f). This force could be an applied force from an installer or from an automated panel insertion device or vehicle, or this force could be provided simply by the weight of the solar panel, for example. Rotation of the lever arm in this instance causes the ground bar associated with the support base to rotate about its panel mount support pivot 116. In other words, the downward lever action causes the bar immediately adjacent to the support base ground linkage (which includes a ground bar 188) to be forced upward, thus causing the balance of the bars, including the bars associated with the ground pivot 116 and the over-center linkage 182, to rotate into position suitable for locking the support column ground linkage against an upper facial surface of the solar panel frame. As shown in FIG. 29C, in some instance, a latching force may be applied to the over-center linkage 182 at about the over-center pivot joint 184 so that the over-center bars 186 may be rotated beyond alignment until one or both of the over-center bars come to rest against the support column. FIG. 29D, which is shown as a perspective view for additional clarity, illustrates the over-center linkage at its locked over-center position against the support column, thus locking the solar panel between at least one bar of the over-center linkage assembly and the support base of the panel mount support.

In further detail regarding FIGS. 28A-29D, in some instances, at least one of the bars of the over-center linkage assembly may provide a recessed region (compared to other bars) that is suitable to provide a centering lead-in for an edge a solar panel being inserted. This can be seen to some degree in FIG. 29D where the second bar from the support column 102 (next to the upper ground bar 188) is shown as offset from the ground bar 188 and the other over-center bar 186. In other examples, in some examples, the over-center linkage 182 may be part of an at least a four bar over center linkage assembly 180, which is defined as three (or more) rotatable bars and the fixed structure, e.g. the panel mount support 102A and 102B. In other examples, the over-center linkage may be part of an at least a six bar linkage assembly, which is defined as five (or more) rotatable bars and the fixed structure. In the latter example, the six bar linkage assembly may be at least partially engagable by insertion of a solar panel onto an extended lever arm associated with a ground bar, for example. These solar panel mounting systems can be modified to be a solar panel alignment system by inclusion of alignment structures and/or use of perception sensors, lasers, or the like, for alignment using an automated panel insertion vehicle, for example.

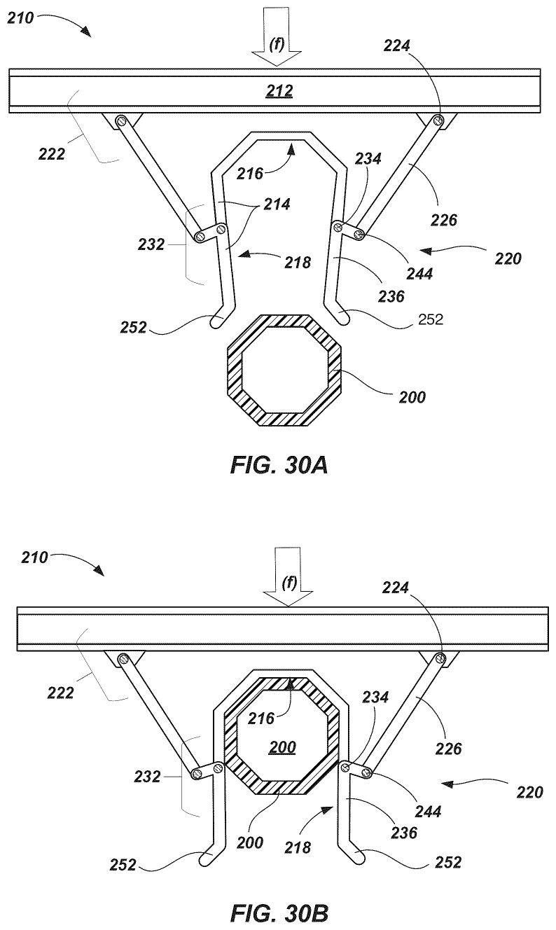

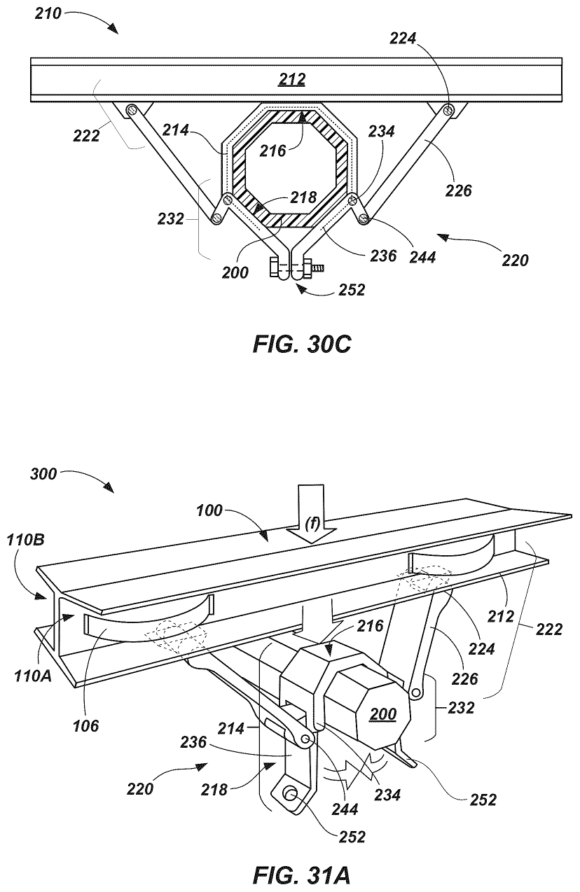

Referring now to the details provided in FIGS. 30A-41B illustrating various torque tube clamps and panel mounts being coupled or integrated into various panel mount clamp assemblies. It is noted that other panel mount clamp assemblies have been previously shown for illustrative purposes, such as in FIGS. 3A-3C, 8A-8C, 15A-15C, 16, 21A-21C, and 26A-26B. To avoid redundancy, some of the other FIGS. previously shown are not shown as part of a panel mount clamp assembly per se, but the disclosure herein makes it clear that any of the panel mounts previously described (whether shown coupled to a torque tube clamp or not) may be combined with any of the torque tube clamps shown and/or described herein.

In general regarding some of the torque tube clamps to be described herein, in some examples, the torque tube clamp can include a clamp support, a torque tube collar having an open torque tube-receiving position and a closed torque tube-locking positon, and a pivotable locking assembly. The pivotable locking assembly may include a ground link with a ground bar coupled to the clamp support by a ground pivot, and an engagement link including an engagement bar directly or indirectly coupled to the ground bar by an engagement pivot. The term “ground” in this instance refers to the pivots and links or bars that are coupled directly to the clamp support of the torque tube clamp or in some instances to the panel mount support of a panel mount, depending on whether the torque tube clamp and the panel mount are integrated as a single unit, e.g., the clamp support and the panel mount support are the same structure, or whether the torque tube clamp and the panel mount are two separate structures that are affixed or coupled together. In other words, the term “ground pivot” and “ground bar” refer to the structure that are directly coupled to a fixed grounding structure of the torque tube clamp or the panel mount, with the balance of the pivots and bar being indirectly attached to these grounding structures through the ground bar, for example.

Regarding the engagement bar, this structure can be part of the torque tube collar and can be movable from the open torque tube-receiving position to the closed torque tube-locking position. In some examples, the torque tube clamp may be integrated with a panel mount so that the panel mount is part of the torque tube clamp per se, or the torque tube clamp can include a separate clamp support that is attached to the panel mount. With the torque tube clamp attached to or integrated with the panel mount, a panel mount clamp assembly is formed. In further detail, it is notable that many of the examples herein illustrate a panel mount clamp that is self-locking by applying a force to the torque tube clamp in the single direction, e.g., without the need of using additional fasteners. For example, the torque tube collar can be modified from its open torque tube-receiving position to its closed torque tube-locking position by application of a force at a location other than at the torque tube collar. In other examples, the closed torque tube-locking position may benefit from a subsequent procedure or action, e.g., the closed torque tube-locking position is secured or locked in place by use of a separate fastener or a fastener that is integrated or attached to the pivotable locking assembly. These and other embodiment are illustrated by way of example in FIGS. 30A-41B hereinafter, as well as in many of the preceding FIGS. as previously described.

FIGS. 30A-30C illustrate an example torque tube clamp 210 that can be attached to or integrated as part of a panel mount, e.g., FIGS. 3A-3B at 100, in accordance with the present disclosure. Regardless of the configuration (attached or integrated), when the panel mount is present, this device can be referred to as a panel mount clamp assembly, which is shown in FIGS. 3A-3B, as well as in FIGS. 10A and 11A, for example. This will be the case with any of the examples described hereinafter, regardless of whether the clamp support is specifically identified as being attached to or integrated as part of the panel mount.

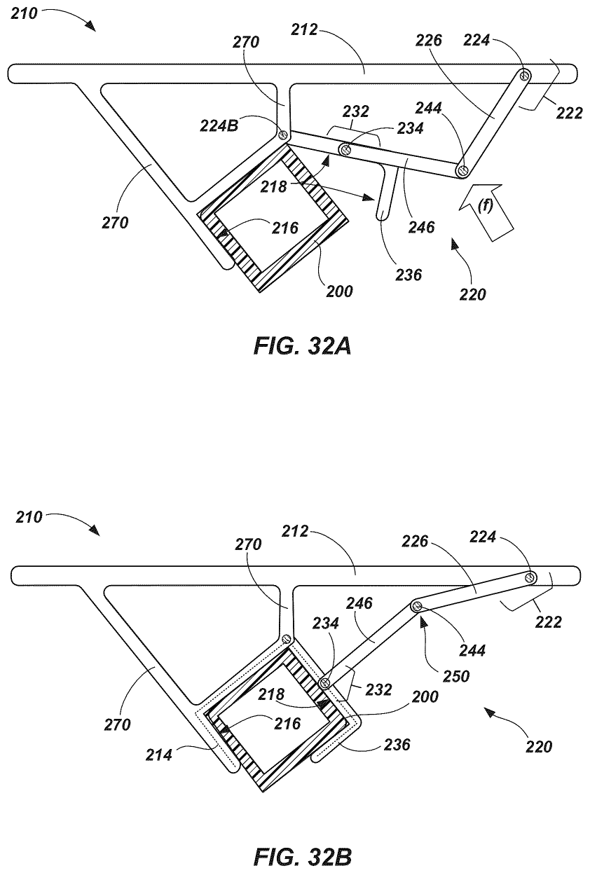

In the example shown at FIG. 30A, a pivotable locking assembly 220 is shown that includes a pair of ground linkages 222, each connecting a clamp support 212 with ground bars 226 and via a ground pivot 224, respectively. The ground bars on both sides are independently connected to a pair of engagement collar portions 216 of a torque tube collar 214 via intermediate pivots 244. In this example, the torque tube collar also includes a fixed collar portion 216, which in this case is not directly coupled to the clamp support, but rather is suspended between two engagement collar portions. In the example shown, the torque tube collar is biased in a partially closed position, e.g., smaller in size at its opening than the cross-sectional size of the torque tube 200. The partially closed position of the torque tube collar is formed of a material or other mechanism so that it may expand and be seated about the torque tube, as shown in FIG. 30B, upon application of a force (f). The applied force in this instance is a downward force in the direction of the torque tube. The force in this example thus provides two mechanical actions. As shown in FIG. 30A transitioning to FIG. 30B, the force applied will cause the torque tube collar to expand about the torque tube so that the torque tube can become fully seated within the fixed collar portion. Next, as shown in FIG. 30B transitioning to FIG. 30C, the continued downward force (f), will mechanically actuate the pivotable locking assembly such that the ground linkages rotate, causing the engagement bars to close at least partially beneath a bottom portion of the torque tube. Once in this closed position, the engagement bars in close proximity may be locked in place by any of a number of multi-bar coupling mechanisms 252. For example, the multi-bar coupling mechanism may provide features such as apertures, grooves, or other profiles or openings suitable for coupling the multiple bars (in close proximity) together using a separate fastener, e.g., bolts, screws, clips, pins, latches, etc., such as that shown by way of example in FIG. 30C. Alternatively, the multi-bar coupling mechanism may be a self-locking mechanism, such as that shown in FIG. 11A, where strong magnets are used to close and secure the two engagement bars together beneath the torque tube. Example self-locking mechanisms that may be suitable for use may include attached structures, including attached or integrated magnets, attached coupling clips, attached male and female connectors, pre-applied adhesives, hook-and-loop, mushroom head fasteners, screws, rivets, friction, elastic deformation, plastic deformation, etc. In this example, the pivotable locking assembly includes ground bars and engagement bars, but does not include an intermediate bar, as is more typically the case with pivotable locking assemblies including an over-center linkage mechanism, e.g. see FIGS. 32A-37B.

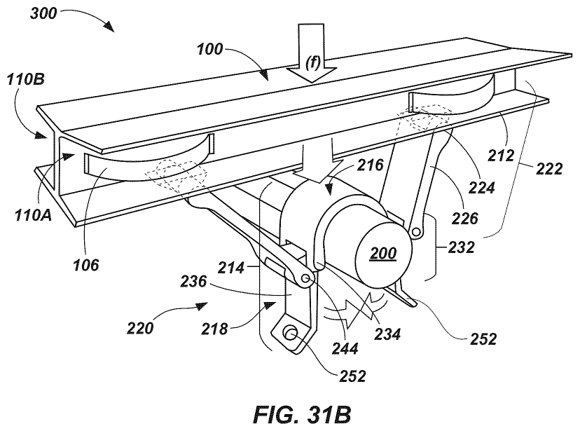

Turning now to FIG. 31A, a similar torque tube clamp 210 is shown, which in this instance is in the form of a panel mount clamp assembly 300. Thus, the clamp support is provided by the panel mount 100. The panel mount is used to receive and retain an edge of a solar panel (not shown) on one side and a second edge of a second solar panel (not shown) on the other side during installation. An example of this is shown in FIGS. 3A-3B. In this example, a pivotable locking assembly 220 is shown that includes a pair of ground linkages 222, each connecting the panel mount (which is the clamp support) with ground bars 226 and via a ground pivot 224, respectively. The ground bars on both sides are independently connected to a pair of engagement collar portions 216 of a torque tube collar 214 via intermediate pivots 244. In this example, the torque tube collar (which has an octagon-shaped inner profile to match the octagon-shaped torque tube 200) also includes a fixed collar portion 216, which in this case is not directly coupled to the clamp support, but rather is suspended between two engagement collar portions. Notably, only an intermediate stage of installation is shown, which is analogous than that shown in FIG. 30B, but this panel mount clamp would operate similarly to that shown in FIGS. 30A-30C. In the example shown, the torque tube collar is biased in a partially closed position, e.g., smaller in size at its opening than the cross-sectional size of the torque tube 200. Again, a partially closed position of the torque tube collar (not shown, but shown in FIG. 30A) may be provided by a material or other mechanism biased in the partially closed position so that it may expand and be seated about the torque tube, as shown in FIG. 31A, upon application of a force (f). Continued application of the force mechanically actuates the pivotable locking assembly such that the ground linkages rotate, causing the engagement bars to close at least partially beneath a bottom portion of the torque tube. Once in this closed position, the engagement bars in close proximity may be locked in place by any of a number of multi-bar coupling mechanisms 252, as previously described. Notably, in this particular example, the panel mount includes two different types of retaining features, namely a retaining channel 110 (or C channel) as well as a pair of biasing structures 106. The retaining channel on one side includes an orthogonally oriented upper and lower wall compared to a central (vertical) wall. The other retaining channel includes one orthogonally oriented lower wall relative to the central vertical wall, with the upper wall being angled upward in a manner suitable for angled overhead insertion of a solar panel. In further detail, the torque tube clamp 210 is shown at FIG. 31B has the same configuration as that shown in FIG. 31A, except that the torque tube collar has an arcuate or rounded inner profile to match the outer circumference of the round cross-sectional torque tube shown at 200. These solar panel mounting systems can be modified to be a solar panel alignment system by inclusion of alignment structures and/or use of perception sensors, lasers, or the like, for alignment using an automated panel insertion vehicle, for example.

Referring now to FIGS. 32A-32B, a torque tube clamp is shown that includes a clamp support 212 and a pivotable locking assembly 220 including an over-center linkage mechanism 250. The pivotable locking mechanism includes ground linkage 222, which couples the clamp support with a ground bar 226 by a ground pivot 224. An intermediate bar 244 is coupled to the ground bar via an intermediate pivot 246, and is also coupled to an engagement bar 236 via an engagement pivot 234. In this particular example, a torque tube collar 214 is defined partially by a fixed collar portion 216, and an engagement collar portion 218. The engagement collar portion includes the engagement bar, which is an L-shaped bar in this example. The fixed collar portion in this example is notably coupled with the clamp support by two fixed support beams 270. One of the two fixed support beams includes a second ground pivot 224B (as it is grounded by the clamp support), which allows for rotation of the engagement bar. Rotation of the engagement bar at the second ground pivot from an open torque tube-receiving position, as shown in FIG. 32A, to a closed torque tube-locking positon, as shown in FIG. 32B, may occur by applying a force (f) to the intermediate pivot (in this instance), which is the pivot point of the over-center linkage mechanism in this example. As the torque tube 200 has a square cross-sectional shape, the L-shaped engagement bar (or engagement collar portion) and the L-shaped fixed collar portion can work together to enclose or partially enclose all four sides of the torque tube, preventing any unwanted rotation of the torque tube clamp relative to the torque tube. Furthermore, once the over-center linkage mechanism has been forced to its “over-center” position, or its position beyond alignment, the closure of the torque tube collar against the torque tube acts to stop the over-center linkage from moving beyond a locking position. In other words, the over-center position when the over-center linkage is locked can occur in this example because after the over-center position is reached (as sown in FIG. 32B), the torque tube collar is abutted against the torque tube, preventing the over-center linkage mechanism from moving beyond the locking position shown.

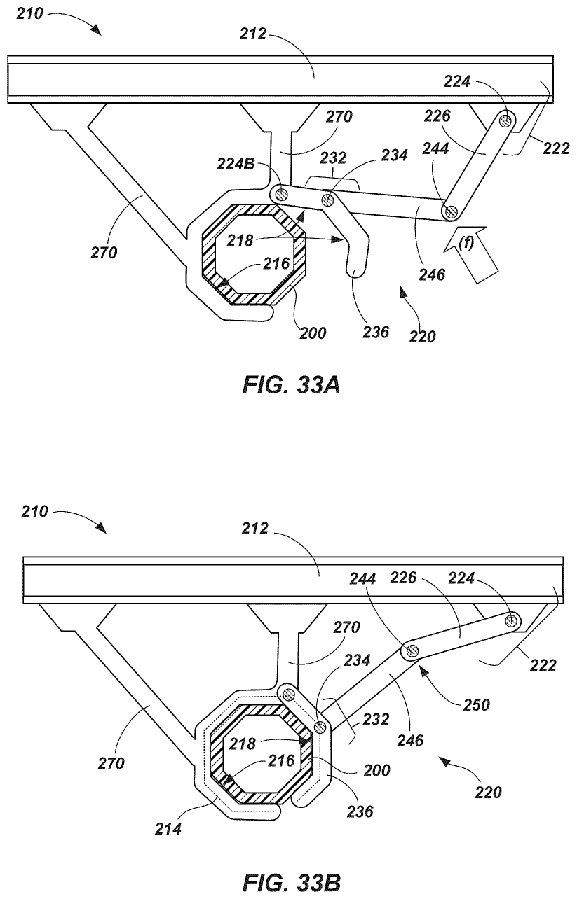

Referring now to FIGS. 33A-33B, a torque tube clamp is shown that includes a clamp support 212 and a pivotable locking assembly 220 including an over-center linkage mechanism 250. The pivotable locking mechanism includes ground linkage 222, which couples the clamp support with a ground bar 226 by a ground pivot 224. An intermediate bar 244 is coupled to the ground bar via an intermediate pivot 246, and is also coupled to an engagement bar 236 via an engagement pivot 234. In this particular example, a torque tube collar 214 is defined partially by a fixed collar portion 216, and an engagement collar portion 218. The engagement collar portion includes the engagement bar, which includes surfaces suitable for engaging with three sides of an octagon in this example. The fixed collar portion in this example is notably coupled with the clamp support by two fixed support beams 270. One of the two fixed support beams includes a second ground pivot 224B (as it is grounded by the clamp support), which allows for rotation of the engagement bar. Rotation of the engagement bar at the second ground pivot from an open torque tube-receiving position, as shown in FIG. 33A, to a closed torque tube-locking positon, as shown in FIG. 33B, may occur by applying a force (f) to the intermediate pivot (in this instance), which is the pivot point of the over-center linkage mechanism in this example. As the torque tube 200 has an octagon cross-sectional shape, the shape of the engagement bar (or engagement collar portion) is such to engage with three sides of the octagon, and the fixed collar portion is configured to engage with the remaining five sides of the octagon-shaped torque tube, including at the lowermost surface of the torque tube for support from beneath. Thus, the engagement collar portion and the fixed collar portion can work together to enclose or partially enclose all eight sides of the torque tube, preventing any unwanted rotation of the torque tube clamp relative to the torque tube. That stated, it is understood that other arrangements can be used that do not interface with all eight sides of the octagon-shaped torque tube. For example, the engagement bar shown could be configured with two surfaces, leaving open the lower right quadrant of the octagon-shaped torque tube. Even with seven sides being surrounded by the torque tube collar, the torque tube would still remain securely fastened within the torque tube collar. As mentioned, once the over-center linkage mechanism has been forced to its “over-center” position (see FIG. 33B), which is in position beyond alignment of the ground bar and the intermediate bar, the closure of the torque tube collar against the torque tube prevents the over-center linkage from moving further beyond the locking position shown. In other words, the over-center position can provide self-locking in this example because after the over-center position is reached, the torque tube collar is abutted against the torque tube, preventing the over-center linkage mechanism from moving beyond the locking position shown.

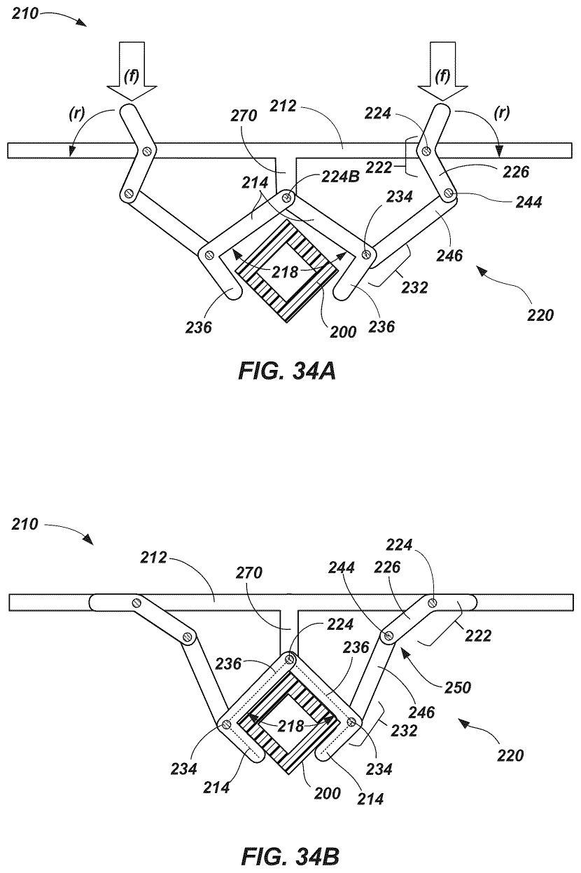

Referring now to FIGS. 34A-34B, a torque tube clamp is shown that includes a clamp support 212 and a pivotable locking assembly 220 including an over-center linkage mechanism 250. However, rather than having a torque tube collar 214 with a fixed collar portion and an engagement collar portion, this example includes two engagement collar portions 218 that work together to squeeze the torque tube 200 therebetween when the over-center linkage mechanisms 250 are simultaneously actuated. The pivotable locking mechanisms include ground linkage 222, which couples the clamp support with ground bars 226 by ground pivots 224. Intermediate bars 244 are coupled to the ground bars via intermediate pivots 246. The intermediate bars are coupled to engagement bars 236 via engagement pivots 234. In this particular example, the engagement collar portion includes the multiple engagement bars, which are both L-shaped bars in this example. A fixed support beam 270 also includes a ground pivot 224 (as it is grounded by the clamp support), which allows for rotation of the engagement bars. Rotation of the engagement bars from an open torque tube-receiving position, as shown in FIG. 32A, to a closed torque tube-locking positon, as shown in FIG. 32B, may occur by applying a force (f) in a downward direction (in a direction orthogonal to or toward the torque tube). The downward force may be applied simultaneously to both ground bar lever arms 260 by an elongated structure, such as a panel mount being attached to the clamp support, or alternatively if the clamp support is a panel mount, the simultaneous downward force may be provided to both ground bar lever arms using a solar panel during installation. Thus, the installation of the solar panel provides the force, such as during automation, which may also lock the torque tube clamp onto the torque tube. As the torque tube 200 has a square cross-sectional shape, the L-shaped engagement bars can work together to enclose or partially enclose all four sides of the torque tube, preventing any unwanted rotation of the torque tube clamp relative to the torque tube. Furthermore, once the over-center linkage mechanism has been forced to its “over-center” position, or its position beyond alignment, the closure of the torque tube collar against the torque tube acts to stop the over-center linkage from moving beyond a locking position. In other words, the over-center position when the over-center linkage is locked can occur in this example because after the over-center position is reached (as sown in FIG. 8B), the torque tube collar is abutted against the torque tube, preventing the over-center linkage mechanism from moving beyond the locking position shown.

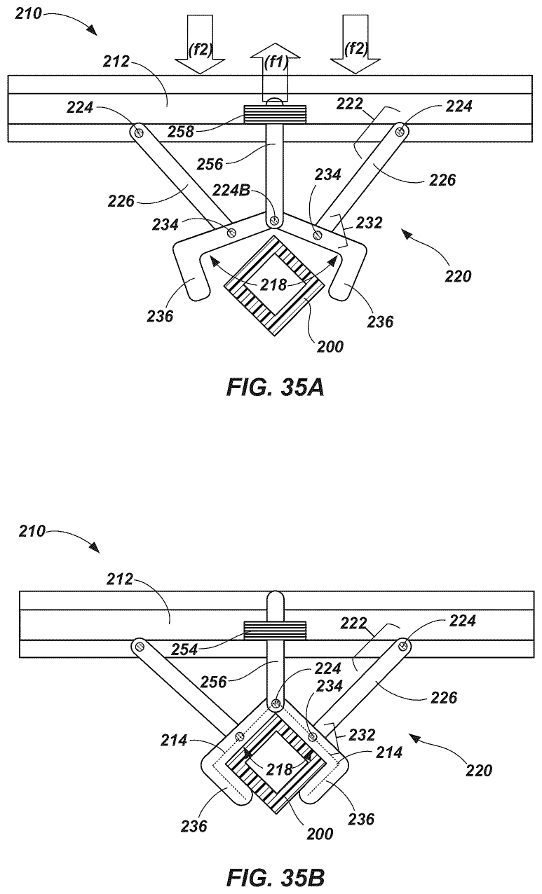

Referring now to FIGS. 35A-35B, a torque tube clamp 210 is shown that includes a clamp support 212 and a pivotable locking assembly 220. The pivotable locking assembly in this example includes a slidable locking mechanism with a locking channel 254 and a slidable bar 256, which together may be self-locking upon application of a single directional force. In this example, the single directional force (f1) may occur by pulling the slidable bar into or through a locking channel, e.g., gears, engagement teeth, zip tie-like engagement, etc. This force will provide a mechanism for closing of a torque tube collar 214 about a torque tube 200. Alternatively, rather than pulling on the slidable bar to actuate the closing of the torque tube collar about the torque tube, a generally downward force (f2) in the direction of the torque tube can be instead exerted, with the top of the slidable bar (or one of the engagement bars 236) providing a base against which the slidable bar moves into or through the locking channel. The down ward force can be exerted by applying a downward force to a panel mount (not shown) attached to or attachable to the clamp support, or if the panel mount is already attached to or integrated as part of the torque tube clamp, then a force applied to a solar panel during installation may be used to provide a downward force (f2), for example. Thus, in this example, like in FIGS. 34A-34B, rather than having a torque tube collar with a fixed collar portion and an engagement collar portion, this example includes two engagement collar portions 218 that work together to squeeze the torque tube therebetween. In further detail, the pivotable locking mechanisms include ground multiple linkages 222, which couple the clamp support with ground bars 226 by ground pivots 224. The ground bars are coupled to engagement bars 236 via engagement pivots 234. In this particular example, the engagement collar portion includes the multiple engagement bars, which are both L-shaped bars in this example. Since the slidable bar is grounded to the clamp support, the slidable bar also includes another ground pivot 224B, which allows for rotational articulation of the two engagement bars. More specifically, the engagement bars are shown in an open torque tube-receiving position in FIG. 32A, and may be rotated to a closed torque tube-locking positon, as shown in FIG. 32B, upon application of the pulling (upward) force (f1) or the downward force (f2) described previously. As the torque tube in this example has a square cross-sectional shape, the L-shaped engagement bars can work together to enclose or partially enclose all four sides of the torque tube, preventing any unwanted rotation of the torque tube clamp relative to the torque tube.

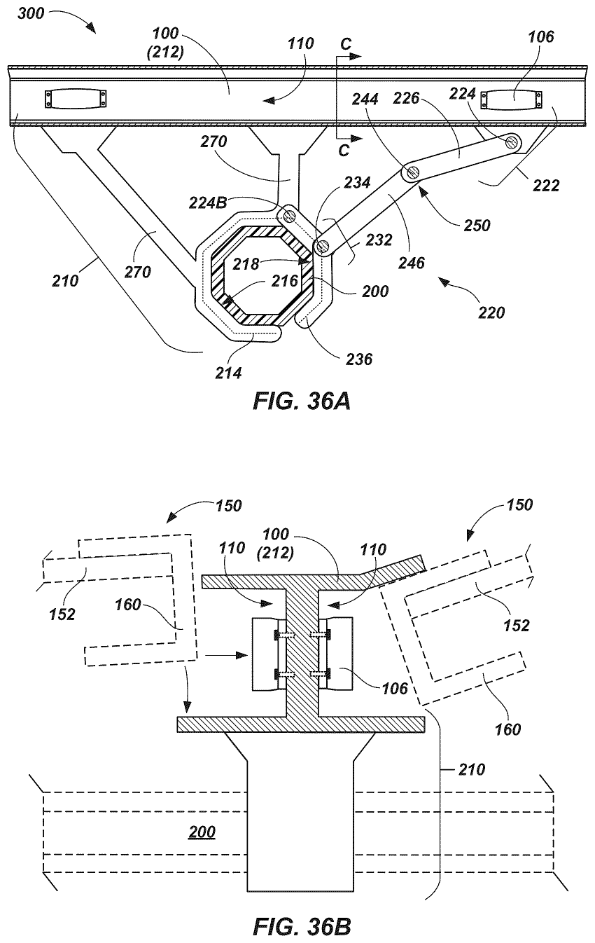

FIGS. 36A-36B illustrate a solar panel mounting system with a panel mount clamp assembly 300 after being immovably fixed onto a torque tube 200. The details of the torque tube clamp 210 are the same as that described previously in FIGS. 33A-33B, with the exception that the clamp support 212 in this example is integrated as part of a panel mount 100. With respect to the torque tube clamp portion of the assembly, the torque tube support (or panel mount) is attached to a pivotable locking assembly 220 including an over-center linkage mechanism 250. The pivotable locking mechanism includes ground linkage 222, which couples the clamp support with a ground bar 226 by a ground pivot 224. An intermediate bar 244 is coupled to the ground bar via an intermediate pivot 246, and is also coupled to an engagement bar 236 via an engagement pivot 234. In this particular example, a torque tube collar 214 is defined partially by a fixed collar portion 216, and an engagement collar portion 218. The engagement collar portion includes the engagement bar, which includes surfaces suitable for engaging with three sides of an octagon in this example. The fixed collar portion in this example is notably coupled with the clamp support by two fixed support beams 270. One of the two fixed support beams includes a second ground pivot 224B (as it is grounded by the clamp support), which allows for rotation of the engagement bar. Rotation of the engagement bar at the second ground pivot from an open torque tube-receiving position, as shown in FIG. 33A, to a closed torque tube-locking positon, as shown in FIG. 33B, may occur by applying a force (f) to the intermediate pivot (in this instance), which is the pivot point of the over-center linkage mechanism in this example. As the torque tube 200 has an octagon cross-sectional shape, the shape of the engagement bar (or engagement collar portion) is such to engage with three sides of the octagon, and the fixed collar portion is configured to engage with the remaining five sides of the octagon-shaped torque tube, including at the lowermost surface of the torque tube for support from beneath. Thus, the engagement collar portion and the fixed collar portion can work together to enclose or partially enclose all eight sides of the torque tube, preventing any unwanted rotation of the torque tube clamp relative to the torque tube. Once the over-center linkage mechanism has been forced to its “over-center” position (see FIG. 10B), which is its position beyond alignment of the ground bar and the intermediate bar, the closure of the torque tube collar against the torque tube prevents the over-center linkage from moving further beyond the locking position shown. This solar panel mounting system can be modified to be a solar panel alignment system by inclusion of alignment structures and/or use of perception sensors, lasers, or the like, for alignment using an automated panel insertion vehicle, for example.

In further detail regarding FIGS. 36A-36B, a solar panel mounting system is shown which includes a panel mount 100 of the panel mount clamp assembly 300 that similar to that shown by way of example in FIGS. 3A-3B. As shown, the panel mount can include one or multiple retaining features, which in this instance, provides both retaining channels 110 (facing opposite directions for engaging two different solar panels 150. The solar panels shown include a solar panel element 152 and a support frame 160, but the panel mount could be alternatively configured to receive a support rail(s) of a frameless solar panel. The panel mount in this example is attached to or integrated with the torque tube clamp 210, which is shown as being tightly clamped on a torque tube 200, which in this instance is shown in both cross-section (FIG. 36A) and in plan side view (FIG. 36B) in the shape of an octagon. The octagon shape engaged with the torque tube collar 214 provides an immovable connection that will prevent rotational slippage about the octagon shaped surface. In this particular example, the panel mount also includes a second retaining feature, namely a biasing structure 106. More specifically, like the two retaining channels that face opposite directions, there are two biasing structures that also face in opposite directions, thus providing a bi-directional panel mount with two retaining features each for engaging two adjacently placed solar panels, e.g., one for retaining one solar panel and another for retaining another adjacently placed solar panel. Like the example shown in FIGS. 3A-3B, though each retaining channel is in the form of a C-channel, one of the C-channels includes a portion of an upper channel wall that is angled at greater than about 95° relative to its rear channel wall. In some examples, the C-channel that includes the angled portion can act to first receive an edge of a solar panel, followed by the dropping in of the other edge of the solar panel at an adjacent panel mount without the angled portion. It may be beneficial in some examples, for the upper channel wall that is angled to provide a deeper channel than the other upper channel wall, so that the second edge may be dropped in and then slid into place without obstruction. In this instance, the opposing biasing structures can provide tension on opposing sides of the solar panel to center the solar panel between two adjacent panel mounts, for example.

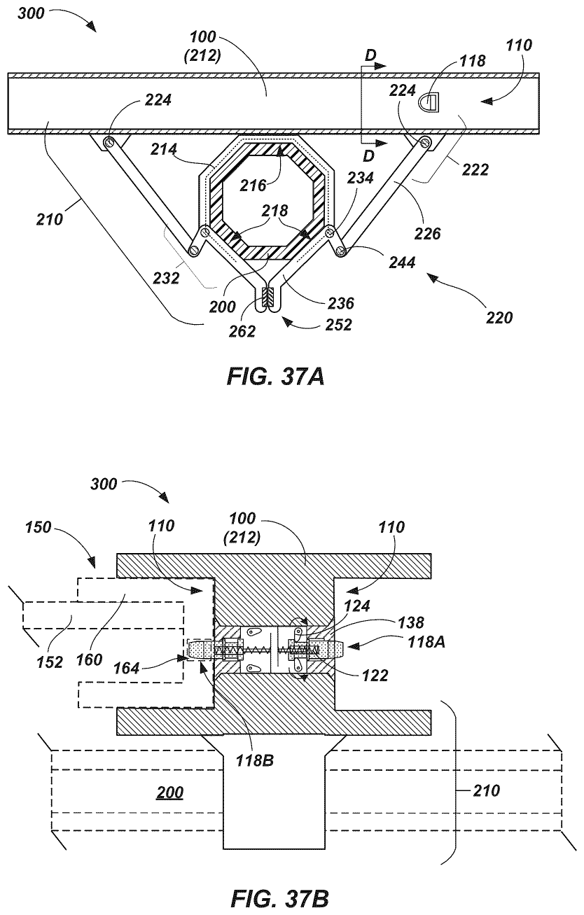

Referring now to FIGS. 37A-37B, a solar panel mounting and alignment system is shown with an alternative panel mount clamp assembly 300 that is immovably fixed onto a torque tube 200. The details of the torque tube clamp 210 are similar to that described previously in FIGS. 30A-30C and FIG. 31A, with the exception that the clamp support 212 in this example is integrated as part of a panel mount 100 with two retaining features, namely a retaining channel 110 and spring-loaded pins 118A-118B. With respect to the torque tube clamp, included is a pivotable locking assembly 220 including a pair of ground linkages 222, each connecting a clamp support 212 with ground bars 226 and via a ground pivot 224, respectively. The ground bars on both sides are independently connected to a pair of engagement collar portions 216 of a torque tube collar 214 via intermediate pivots 244. In this example, the torque tube collar also includes a fixed collar portion 216, which in this case is not directly coupled to the clamp support, but rather is suspended between two engagement collar portions. The engagement of the torque tube 200 with the torque tube collar can be as described previously in connection with FIGS. 30A-30C and FIG. 31A, for example. Upon application of the force shown in those prior examples, rotation of the ground linkages causes the engagement bars to close at least partially beneath a bottom portion of the torque tube. Once in this closed position, the engagement bars in close proximity may be locked in place by any of a number of multi-bar coupling mechanisms 252. In this example, a pair of strong magnets are shown with a north pole of one magnet and a south pole of the other magnet facing one another. The magnets used may be permanent magnets, electromagnets, or any other type of magnet that will assist in the torque tube collar remaining locked about the torque tube.

Unlike the two retaining features shown on the panel mount 100 in FIG. 31A, in this example shown in greater detail in FIG. 37B, in addition to the retaining channel 110, the second retaining feature can be a spring-loaded pin 118. This particular spring-loaded pin is suitable for lateral (slidable) insertion of the solar panel, rather than overhead insertion as shown and described in FIGS. 3A-3B, FIG. 31A, and FIGS. 36A-36B, for example. Though a simple spring-loaded pin may be used that simply retracts and returns to its original position once a panel support aperture 164 becomes aligned with the pin, in this example, a more complicated spring-loaded pin is used that will more securely lock in place the solar panel with a deeper penetrating pin with a non-angled portion engaging with the panel support aperture. More specifically, the spring-loaded pins are configured as multi-level engagement pins, meaning that in addition to the configuration where the pin is initially retractable (118A) and subsequently completely retracted (not shown), upon being released from complete retraction, the pin is configured to more fully protrude (118B) from the panel mount, providing a more substantial locking mechanism for the pin when seated within the panel support aperture. In further detail, the pin is associated with a spring 122, a pin-retaining feature 138, and a pin lever mechanism 124 (that may be spring-loaded as well) that work together to provide the multiple elevations prior to engagement with the solar panel and then after engagement with a panel support aperture of the solar panel. As shown at 18A, prior to engagement with the solar panel, the spring-loaded pin is at its initial position, biased partially outward and held in place by the pin lever mechanism. Upon engagement with the solar panel during a slidable insertion event, the pin lever mechanism rotates out of the way. Then, when the panel support aperture is aligned with the spring-loaded pin, the pin can become seated in the panel support aperture at its extended engagement elevation, which includes a non-tapered portion, thereby preventing the solar panel from slipping further along the retaining channel, for example.

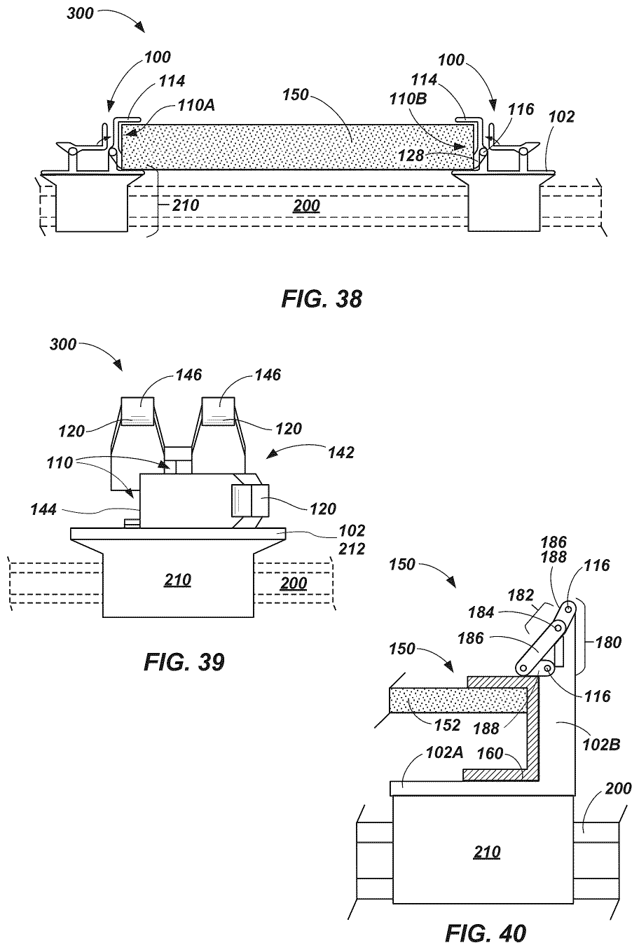

Referring now to FIG. 38, an example panel mount clamp assembly 300 is shown that includes the panel mount 100 shown and described in connection with FIGS. 7A-7C. As shown, the panel mount can be coupled to or incorporated into a torque tube clamp 210 of a panel mount clamp assembly. Notably, the panel mount includes multiple lever portions 128 incorporated into a channel wall that defines two respective retaining channels 110A and 110B. For example, FIGS. 7A and 7C depicts the panel mounts with retaining features in an open orientation, and FIG. 7B depicts the retaining features of panel mounts in a closed orientation after insertion of a solar pane 150. It is understood that the solar panel would likely include a support frame or support rails and solar panel element (not shown). Thus, when inserting the solar panels into the panel mounts (one on each side), facial edges of the solar panels would interface respectively with the lever portions, causing the retaining features to rotate about a panel mount support pivot 116. Thus, in this instance, a solar panel can be installed overhead by inserting the solar panels onto the lever portion of one of the retaining features of two adjacent panel mounts with a downward force, causing the positions of the retaining channels to rotate so that upper walls 114 of the retaining channel rotate above the solar panel. In further detail, the lever portion is angled and has a thickness suitable for providing a relatively snug fit when the solar panel is fully seated between the respective retaining channels. In short, the panel mounts shown in FIGS. 7A-7C and FIG. 38 can be pivotable or pivoted to an open orientation to provide clearance for overhead solar panel insertion into the support channels, and upon insertion, the panel mounts can then be pivoted to a closed orientation upon application of a downward force, such as to the solar panel. Notably, on each of the panel mounts, there are offset rotatable retaining features for engaging with additional solar panels installed to the right and the left of the solar panel. This solar panel mounting system can be modified to be a solar panel alignment system by inclusion of alignment structures and/or use of perception sensors, lasers, or the like, for alignment using an automated panel insertion vehicle, for example.

In further detail, and in particular as show in FIG. 38, the panel mount 100 of the panel mount clamp assembly 210 is shown as being attached to a torque tube clamp 210 to form the torque tube clamp assembly. The torque tube clamp portion can be in the configuration of any of the torque tube clamps illustrated and described previously in in connection with FIGS. 3A-3C, 8A-8C, 15A-15C, 16, 21A-21C, 26A-26B, 30A-41B. The torque tube 200 illustrated in this example is an octagon-shaped torque tube (octagon shape in cross-section), but could be any of the shapes described herein, including square, round, or any other geometric shape, with the torque tube collar having an interior geometry that at least partially matches the outer cross-sectional profile of the torque tube.

Referring now to FIG. 39, a solar panel mounting and alignment system is shown and includes an example panel mount 100 that can be coupled to or incorporated into a torque tube clamp 210 of a panel mount clamp assembly 300. The panel mount shown in this example may include some or all of the features of that shown and descried in connection with FIGS. 16-20. In operation, an example sequence of coupling a solar panel to the lead-in latch assembly 142 is illustrated and described in connection with FIGS. 18A-18D, for example. More specifically, FIG. 39 illustrates the panel mount as including a panel mount support 102 (which may be a clamp support 212 if the panel mount and torque tube clamp are integrated) connected to three lever arms via panel mount support pivots (not shown) as the retaining features, which include an edge lead-in latch 144 and two facial lead-in latches 146 as part of a lead-in latch assembly 142. Each of the lead-in latches is equipped with an engagement protrusion 120 that will align with various panel support apertures 164 (not shown) when the solar panel is slid into place through the retaining channel 110. Thus, the engagement protrusions slide along two support frame surfaces, generating some pressure against these two support frame surfaces as well as against panel mount support. Once the engagement protrusions of the edge lead-in latch and one of the facial lead-in latches reaches their respective panel support apertures, the protrusions drop into the apertures, relieving pressure on the elongated arms of the lead-in latches. With the protrusions seated within the panel support apertures, the solar panel becomes locked in place along two different orthogonal surfaces of the support frame, generating a secure and stationary installation. Notably, one of the facial lead-in latches is used at the opposite edge of the next solar panel to be installed.

Referring now to FIG. 40, an example panel mount clamp assembly 300 is shown that includes a panel mount 100 coupled to or incorporated into a torque tube clamp 210. More specifically, FIGS. 40 is illustrative of a panel mount clamp assembly that could be used with the panel mounts shown and described in connection with FIGS. 28A-29D. In example, the panel mount includes two panel mount support pivots 116 or ground pivots 116 being attached to a support column 102B of the panel mount support 102. Notably, as there are three links or bars in this example, it is notable that two of the bars 186 are part of an over-center linkage 182 and one of those two bars 186, 188 is attached to a ground pivot 116 of a ground linkage, which includes a ground bar 188. Thus, the bar associated with the lowermost ground pivot is also part of the over-center linkage. In operation, the solar panel is dropped into place and is supported below by the support base 102A. In this position, the solar panel is in position to be locked into place by applying a latching force (f) to the over-center linkage at about the over-center pivot joint 184, such that when two over-center bars attached to the over-center pivot joint are rotated beyond alignment, one or both of the over-center bars come to rest against the panel support column. In this example, there are three bars or links, making this example a four bar linkage (with the panel mount support as a fixed structure providing the “fourth” bar. This solar panel mounting system can be modified to be a solar panel alignment system by inclusion of alignment structures and/or use of perception sensors, lasers, or the like, for alignment using an automated panel insertion vehicle, for example. However, in some examples, one or more of the bars during solar panel installation can provide a protrusion that can be used for panel mount alignment in accordance with the present disclosure (See FIG. 29D).

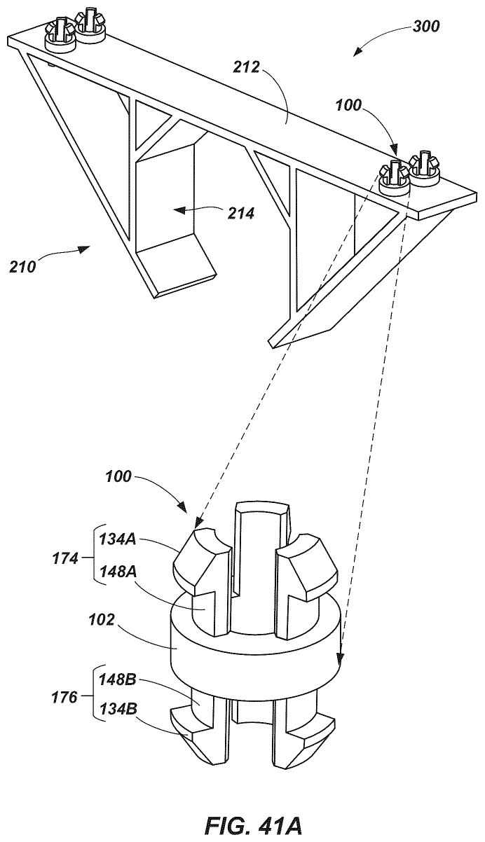

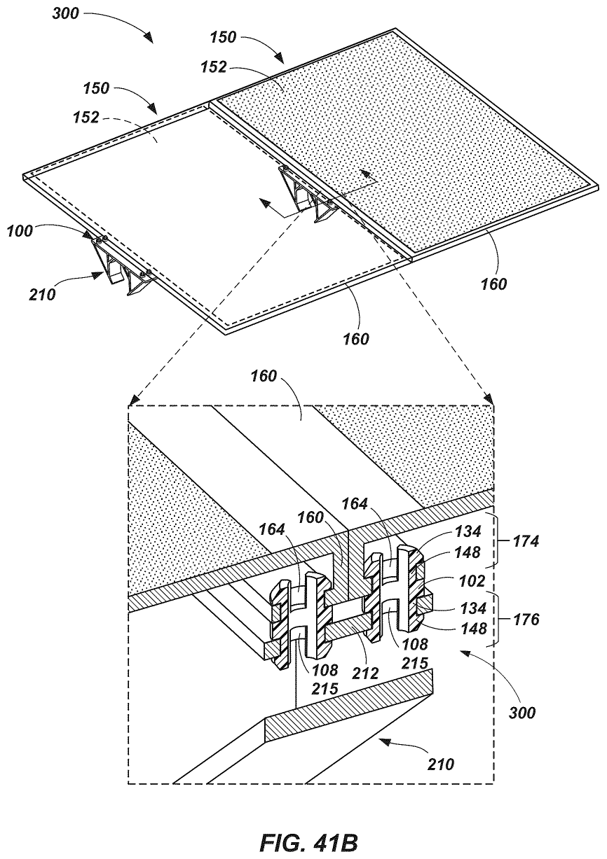

Referring now to FIGS. 41A-41B, a solar panel mounting and alignment system can include panel mount 100, which is shown as being attached to a torque tube clamp 210 at a clamp support 212 thereof, forming a panel mount clamp assembly 300. The torque tube clamp is configured with a torque tube collar 214 configured for attached to a torque tube (not shown) having a cross-sectional shape of an octagon to prevent lateral rotation of the clamp when attached to the torque tube. The panel mount is shown as it is attached to the clamp support (FIG. 41A) as well as how a solar panel may be attached to the panel mount by overhead insertion (FIG. 41B).

Referring more specifically to FIG. 41A, four panel mounts 110 in the form of double-sided snaps are shown as being attached to a clamp support 212 of a torque tube clamp 210. The clamp support includes multiple clamp support apertures therethrough (not shown in FIG. 41A, but shown in cross-section in FIG. 41B at 215) for receiving the double-sided snaps. More specifically, a panel mount supports 102 rests on top of the clamp support, each having a clamp-side snap 176 with a lower standoff 148B and a lower retaining button 134B. The panel mount supports (or middle rings) are configured to prevent the panel mount from passing through the clamp support apertures. Thus, the clamp-side snaps are passed through the clamp support apertures to connect the panel mounts to the clamp support of the torque tube clamp. Above the panel mount supports are panel-side snaps 174, each including an upper standoff 148A and an upper retaining button 134A. In this configuration, the panel-side snaps are individually in position to receive a solar panel at its panel mount apertures 164 during overhead installation of the solar panels. As there are two sets of panel mounts, two panel mounts are used to snap in place one side of a first solar panel, and two of the panel mounts are used to snap in the opposite side of a second solar panel, as shown in FIG. 41B.

Referring now to FIG. 41B, two solar panels are shown at 150, each including a solar panel element 152 (one shown in phantom lines for visibility beneath the solar panel) and a solar panel frame 160. The solar panel frame includes multiple panel mount apertures 164. Notably, in an example where the solar panel is a frameless solar panel supported by support rails (not shown, but shown in FIG. 2A), the panel mount apertures would be located in the support rails and the panel mount would be configured to align with the apertures of the support rails. As can be seen in this FIG., the panel mounts, which are in the form of double-sided snaps, are configured to engage the clamps support apertures 215 at its clamp-side snap and also engage the panel mount apertures 164 at its panel-side snap. The retaining buttons 134 are configured to be able to pass through their respective apertures due to an inward flex of the standoff structure, which can be flexible due to its relative thickness compared to the retaining buttons, e.g., the standoff are thinner than the retaining buttons, as well as the choice of material, for example. In this example, the sloping retaining buttons can assist with causing the standoffs in deflecting inward so that the portions above and below the panel mount support (or middle ring) can pass through their respective apertures. In this example, removal of the solar panels can be carried out by compressing the retaining buttons inward circumferentially, if there is a need to remove a solar panel from a solar panel array. Notably, the clamp support apertures are also notated by reference numeral 108, indicating examples where the clamp support acts as a base support of the panel mount, e.g., when the panel mount and the torque tube clamp are integrated as a single unit.

Furthermore, as with other examples herein, these double-sided snap panel mounts 100 can be preinstalled onto the clamp support 212 (or panel mount support, notated by 108) of the torque tube clamp 210, or can be installed at the same time or just prior to installation of the solar panels. Notably, with this arrangement, adjacent solar panels can be placed in close proximity to one another because there is no support column, per se, in this example as part of the panel mount assembly.

### Methods of Aligning Solar Panels

Methods of installing and aligning solar panels can be carried out using the solar panel alignment systems described herein. In one example, a method of installing and aligning solar panels can include coupling a plurality of bi-directional panel mounts at multiple locations along an elongated torque tube, with distance intervals suitable for receiving and retaining a plurality of solar panels individually installed between immediately adjacent bi-directional panel mounts. The plurality of bi-directional panel mounts may include a retaining feature assembly a first retaining feature assembly to receive a first side of a first support frame or a first support rail of a first solar panel, and a second retaining feature assembly configured to receive a second side of a second support frame or second support rail of a second solar panel. One or both of the first retaining feature assembly or the second retaining feature assembly can include an alignment structure to ensure lateral edges of the first solar panel are aligned with lateral edges of the second solar panel when the first solar panel and the second solar panel are fully engaged with the first retaining feature and the second retaining feature, respectively. The method can further include installing the plurality of solar panels between the immediately adjacent bi-directional panel mounts to engage with the first retaining feature, the second retaining feature, or both such that the first solar panel and the second solar panel are laterally aligned.

In another example, a method of aligning and installing solar panels can include coupling a plurality of panel mounts at multiple locations along an elongated torque tube, with distance intervals suitable for receiving and retaining a plurality of solar panels individually installed between immediately adjacent panel mounts. The plurality of panel mounts can include a first retaining feature assembly to receive a first side of a first support frame or a first support rail of a first solar panel, and a second retaining feature assembly configured to receive a second side of a second support frame or second support rail of a second solar panel. The method can also include installing the plurality of solar panels between the immediately adjacent panel mounts using an automated solar panel insertion vehicle with sensory equipment for sensing alignment or misaligned lateral edges of a plurality of solar panels being installed into the plurality of panel mounts when connected to the torque tube. The sensory equipment can communicate with installation mechanisms to adjust the misaligned lateral edges of one or more of the multiple solar panels based on data collected by the sensory equipment. In some examples, the panel mounts can be bi-directional panel mounts.

In accordance with examples of these methods of installing and aligning solar panels, in some examples, the lateral edges of the first and second solar panels can be aligned in parallel with the torque tube. These edges are typically the edges that do not include a support structure with retaining features, as in these example support structures and retaining features are typically present along edges of the solar panel that are perpendicular to the torque tube. Thus, when installing, the misalignment may typically occur where there may not be a support structure present with retaining features. In some examples, to provide for solar panel centering between retaining features (perpendicular to the torque tube), the first retaining feature assembly or the second retaining feature assembly may include a biasing structure to provide for more consistent centering and substantially equal spacing between adjacently installed solar panels.

Example of retaining features that also act as alignment structures that can provide for lateral alignment of solar panels include spring-loaded pins, fixed pins functionally coupled with a biasing structures, rotatable pin assemblies, levered pin assemblies, flexible structures with retaining buttons, lead-in latch assemblies, panel-side snaps, or a combination thereof. Other retaining features may include fixed retaining channels, biasing structures, pivoting retaining channels, or a combination thereof.

Example alignment structure may be in the form of a pin or protrusion can be adapted to be received by a panel support aperture when installing the solar panel. Thus, the pin or protrusion and the panel support aperture may each be positioned to ensure alignment of the lateral edges of adjacently installed solar panels. In other examples, the alignment structure may be in the form of a fixed pin. For example, a first fixed pin may be a first retaining feature and a second fixed pin that is shorter in length than the first fixed pin may be a second retaining feature. In this arrangement, the first retaining feature assembly may also include a biasing structure or spring. In another example, an alignment structure may include a spring-loaded pin, such as spring-loaded pin associated with an engagement lever that engages with a solar panel being installed at one or both of the first or second retaining feature assemblies, a spring-loaded pin is associated with a rotatable pin assembly that engages with a solar panel being installed at one or both of the first or second retaining feature assemblies, or a spring-loaded pin is associated with a multi-level engagement pin. In other examples, an alignment structure may include a pin or protrusion as part of a lead-in latch assembly. Example lead-in latch assemblies may include a facial lead-in latch and an edge lead-in latch as part of the first retaining feature assembly. In other examples, the lead-in latch assembly may include a second facial lead-in latch as part of the second retaining feature assembly. Another alignment structure may include a flexible structure with a retaining button that engages with a panel support aperture. Thus, the retaining button and the panel support aperture are each positioned to ensure alignment of the lateral edges of adjacently installed solar panels. In other examples, the alignment structure can include a panel-side snap including a flexible standoff and a retaining button that engages with a panel support aperture. In this example, the panel-side snap and the panel support aperture are each positioned to ensure alignment of the lateral edges of adjacently installed solar panels. In other examples, the alignment structure may include a retaining channel with a stopper structure suitable for ensuring that a solar panel is not installed laterally beyond the stopper structure. In some examples, the alignment structure can be present as part of an over-center linkage assembly.

In some examples, in addition to the alignment structure(s), at least one of the first retaining feature assembly or the second retaining feature assembly includes retention structure to retain the solar panel at the support frame or support rail. Example retention structures may include, for example a retaining channel, a flexible structure with a retaining button or flexure lock, an over-center linkage assembly, or a combination thereof.

In further detail, the panel mounts (or the bi-directional panel mounts) can be attachable to, attached to, or integrated with a plurality of torque tube clamps, and the torque tube clamps can be attachable to, or attached to, a torque tube. For example, the torque tube clamps may include torque tube collar having an inner surface geometry that when locked on the torque tube having an at least partially matching cross-sectional outer surface geometry. Furthermore, the panel mounts may be prevented from rotating about the torque tube by slippage, and only rotate about the torque tube in coordination with the rotational movement of the torque tube.

The alignment systems can provide for solar panel alignment during installation in three directions in some examples, including alignment of the lateral edges of adjacently installed solar panels, wherein the lateral edges are positioned in parallel with the torque tube, centering alignment of individual solar panels to provide substantially equal spacing between adjacently installed solar panels, and rotational alignment of installed solar panels to follow rotation of the torque tube without rotational slippage. These alignment systems can provide appropriate architecture for solar panel alignment, even when installed using automation. With respect to automation, an automated panel insertion vehicle in accordance with the present disclosure may include sensory equipment, such as one or more of an alignment laser or a perception sensor. This sensory equipment can be used with retaining features with or with alignment structures, including the presence of any of the following retaining features as part of the first and/or second retaining feature assemblies, namely a fixed retaining channel, a biasing structure, a pivoting retaining channel, a spring-loaded pin, a fixed pin functionally coupled with a biasing structure, a rotatable pin assembly, a levered pin assembly, a flexible structure with a retaining button, a lead-in latch assembly, a panel-side snap, or a combination thereof. In further detail, the automated panel insertion vehicle can be adapted to align the misaligned lateral edges of the one or more solar panels such that the lateral edges are aligned in parallel with the torque tube.

### Definitions

As used herein, the singular forms “a,” “and,” “the,” etc., include plural referents unless the context clearly dictates otherwise.

As used herein, the term “panel mount” refers to a structure or an assembly of structures that is adapted to receive and retain solar panels in an operationally installed position. In some examples, the panel mount includes one or more retaining features, such as a retaining channel, a spring-loaded pin, a flexible structure with a retaining button, a pivoting structure, a biasing structure, a lead-in latch, an over-center linkage, or the like. A plurality of panel mounts can be operable together to provide for sequential installation to form a line of solar panels along a torque tube, or an array of solar panels, for example. The installation of a solar panel along the torque tube typically utilizes two torque tube clamps, each attached to inward facing panel mounts. A panel mount may include multiple retaining features configured to engage with two adjacently installed solar panels, with a first retaining feature to receive a first end of a first solar panel and a second retaining feature to receive a second (opposite) end of a second solar panel. The other side of each of the panel mounts that are not utilized to receive the solar panel are available for receiving immediately adjacent solar panels, e.g., two panel mounts would interface with three solar panels, with the center solar panel engaged on both sides and the other two engaged by the retaining features on the other side of the two respective panel mounts.

As used herein, the term “retaining feature” relates to a portion of a panel mount that directly interfaces with a solar panel in a manner that provides solar panel insertion and/or retention to the solar panel. Typically, the retaining features do not require the use of tools to engage the retaining features, making these retaining features particularly suitable for automated insertion of solar panels between adjacently placed panel mounts (which are typically clamped on a torque tube by a torque tube clamp. Example retaining features may include structures such as a biasing structure, a pin, a spring-loaded pin, a pin-lever mechanism, a flexible structure, a flexure lock, a lead-in latch assembly, an over-center linkage assembly, or the like.

A “solar panel” includes both a “solar panel element,” e.g., PV element, which is the portion of the solar panel that collects radiant energy for conversion to electrical power, and a “panel support,” which is typically in the form of one of two types of structures that provide support to the solar panel element, namely a support frame or a panel rail. A solar panel “support frame” is typically in the form of a rigid material that surrounds the edges of the solar panel element, the combination of the element and the framing making the solar panel. A frameless solar panel does not have a peripheral support frame, but rather is typically supported from beneath by rigid structures, such as one or more support rails. The term “support rail” includes any rigid structure of any shape attached to the underside of a solar panel element that can be used for attachment to a panel mount in accordance with the present disclosure. Thus, a support frame describes a peripheral panel support and the term support rail describes an underside panel support.

As a note, terms like “first,” “second,” “third,” etc. used herein to differentiate structures relative to one another, do not infer order or arrangement. Sometimes, for example, a solar panel may be inserted into a panel mount including a “first” retaining feature, such as a retaining channel, a spring-loaded pin, a flexible panel mount, a lead-in latch, an over-center linkage assembly, etc., followed by a “second” retaining feature. It is understood that any of the retaining features could likewise have a “second” feature followed by a “first” retaining feature without consequence.

Similarly, in some instances, relative direction or orientation language is used herein, such as “upper,” “lower,” “downward,” etc. It is emphasized that these terms are relative and are based on the location of the torque tube, the torque tube clamp(s), and/or the panel mount, depending on the context. For example, if installing a solar panel in a horizontal or flat orientation into a pair of adjacently located panel mounts, then upper, lower, downward, etc., directions or orientations would coincide with those terms as typically used. However, if a solar panel is installed at an angle other than horizontal, a “downward” force would be in a direction toward the panel mount carried by the torque tube.

A “torque tube clamp” is defined as the structure that is attached to the torque tube of a solar panel array so that when the torque tube is rotated orthogonally relative to the torque tube length, the torque tube clamp stays affixed and rotates the same angular degrees as the surface of the torque tube. In some examples, the torque tube clamp can be installed without the use of separate fasteners. For example, the torque tube clamp may include a “self-locking” feature requiring only one force to be applied at a location to cause the torque tube clamp to become immovably locked on the torque tube. The term “self-locking” does not infer that the mechanism locks itself automatically, but rather indicates that when the mechanism is modified from an open torque tube-accepting position to a closed position firmly about the torque tube, that the torque tube clamp can be locked due to the design of the torque tube clamp without the need of additional fasteners, e.g., the closing of the torque tube clamp about the torque tube provides the locking function. The installation of a solar panel along the torque tube typically utilizes two torque tube clamps, each attached to inward facing panel mounts.

The terms “aperture” is used herein in the context of panel support apertures, e.g., openings in solar panel frames and/or solar panel rails, panel mount apertures, e.g., openings in the panel mounts, and clamp support apertures, e.g., openings in the clamp support. However, it is noted that the term “aperture” herein refers to various types of openings, including openings that are punched through a material, openings that are detents that are not punched through a material, or the like. Thus, an aperture includes any recessed structure or hole through a structure that is functional for receiving a pin, latch, bump, or other process in accordance with the present disclosure.

It is to be understood that the examples of the invention disclosed are not limited to the particular structures, process steps, or materials disclosed herein, but are extended to equivalents thereof as would be recognized by those ordinarily skilled in the relevant arts. It should also be understood that terminology employed herein is used for the purpose of describing particular examples only and is not intended to be limiting.

As used herein, a plurality of items, structural elements, compositional elements, and/or materials can be presented in a common list for convenience. However, these lists should be construed as though each member of the list is individually identified as a separate and unique member. Thus, no individual member of such list should be construed as a de facto equivalent of any other member of the same list solely based on their presentation in a common group without indications to the contrary. In addition, various examples of the present invention can be referred to herein along with alternatives for the various components thereof. It is understood that such examples and alternatives are not to be construed as de facto equivalents of one another, but are to be considered as separate and autonomous representations of the present technology.

Furthermore, the described features, structures, or characteristics can be combined in any suitable manner in one or more examples. In the description, numerous specific details are provided, such as examples of lengths, widths, shapes, etc., to provide a thorough understanding of examples of the invention. One skilled in the relevant art will recognize, however, that the invention can be practiced without one or more of the specific details, or with other methods, components, materials, etc. In other instances, well-known structures, materials, or operations are not shown or described in detail to avoid obscuring aspects of the invention.

Reference was made to the examples illustrated in the drawings and specific language was used herein to describe the same. It will nevertheless be understood that no limitation of the scope of the technology is thereby intended. Alterations and further modifications of the features illustrated herein and additional applications of the examples as illustrated herein are to be considered within the scope of the description. Reference throughout this specification to “one example” or “an example” means that a particular feature, structure, or characteristic described in connection with the example is included in at least one example of the present invention. Thus, appearances of the phrases “in one example” or “in an example” in various places throughout this specification are not necessarily all referring to the same example.

Although the disclosure may not expressly disclose that some examples or features described herein may be combined or interchanged with other examples or features described herein, this disclosure should be read to describe any such combinations that would be practicable by one of ordinary skill in the art no matter the specific examples that were described. Indeed, unless a certain combination of elements or functions not expressly disclosed would conflict with one another, such that the combination would render the resulting example inoperable or impracticable as would be apparent to those skilled in the art, this disclosure is meant to contemplate that any disclosed element or feature or function in any example described herein can be incorporated into any other example described herein (e.g., the elements or features or functions combined or interchanged with other elements or features or functions across examples) even though such combinations or interchange of elements or features or functions and resulting examples may not have been specifically or expressly disclosed and described. Indeed, the following examples are further illustrative of several embodiments of the present technology:
Example 1. A solar panel alignment system, comprising a plurality of bi-directional panel mounts connected to or connectable to a torque tube, the bi-directional panel mounts each including a first retaining feature assembly to receive a first side of a first support frame or a first support rail of a first solar panel, and a second retaining feature assembly configured to receive a second side of a second support frame or second support rail of a second solar panel, wherein one or both of the first retaining feature assembly or the second retaining feature assembly includes an alignment structure to ensure lateral edges of the first solar panel are aligned with lateral edges of the second solar panel when the first solar panel and the second solar panel are fully engaged with the first retaining feature and the second retaining feature, respectively.
Example 2. The solar panel alignment system of example 1, wherein the lateral edges of the first and second solar panels are aligned in parallel with the torque tube.
Example 3. The solar panel alignment system of any one of examples 1-2, wherein the first retaining feature assembly or the second retaining feature assembly includes a biasing structure to provide consistent centering and substantially equal spacing between adjacently installed solar panels.
Example 4. The solar panel alignment system of any of examples 1-3, wherein the alignment structure includes a pin or protrusion adapted to be received by a panel support aperture when installing the solar panel, wherein the pin or protrusion and the panel support aperture are each positioned to ensure alignment of the lateral edges of adjacently installed solar panels.
Example 5. The solar panel alignment system of example 4, wherein the alignment structure of the first retaining feature assembly includes a first fixed pin and the second retaining feature assembly includes a second fixed pin that is shorter in length than the first fixed pin, and wherein the first retaining feature assembly also includes a biasing structure or spring.
Example 6. The solar panel alignment system of example 4, wherein the pin or protrusion includes a spring-loaded pin.
Example 7. The solar panel alignment system of example 6, wherein the spring-loaded pin is associated with an engagement lever that engages with a solar panel being installed at one or both of the first or second retaining feature assemblies.
Example 8. The solar panel alignment system of example 6, wherein the spring-loaded pin is associated with a rotatable pin assembly that engages with a solar panel being installed at one or both of the first or second retaining feature assemblies.
Example 9. The solar panel alignment system of example 6, wherein the spring-loaded pin is associated with a multi-level engagement pin or a toggle-type engagement pin.
Example 10. The solar panel alignment system of example 4, wherein pin or protrusion is part of a lead-in latch assembly.
Example 11. The solar panel alignment system of example 10, wherein the lead-in latch assembly includes a facial lead-in latch and an edge lead-in latch as part of the first retaining feature assembly.
Example 12. The solar panel alignment system of example 11, wherein the lead-in latch assembly includes a second facial lead-in latch as part of the second retaining feature assembly.
Example 13. The solar panel alignment system of any one of examples 1-12, wherein the alignment structure includes a flexible structure with a retaining button that engages with a panel support aperture, wherein the retaining button and the panel support aperture are each positioned to ensure alignment of the lateral edges of adjacently installed solar panels.
Example 14. The solar panel alignment system of any one of examples 1-13, wherein the alignment structure includes a panel-side snap including a flexible standoff and a retaining button that engages with a panel support aperture, wherein the panel-side snap and the panel support aperture are each positioned to ensure alignment of the lateral edges of adjacently installed solar panels.
Example 15. The solar panel alignment system of any one of examples 1-14, wherein the alignment structure includes a retaining channel with a stopper structure suitable for ensuring that a solar panel is not installed laterally beyond the stopper structure.
Example 16. The solar panel alignment system of any one of examples 1-15, wherein the alignment structure is present as part of an over-center linkage assembly that is present during installation of a solar panel at least prior to locking the over-center linkage assembly.
Example 17. The solar panel alignment system of any one of examples 1-16, wherein in addition to the alignment structure, at least one of the first retaining feature assembly or the second retaining feature assembly includes retention structure to retain the solar panel at the support frame or support rail.
Example 18. The solar panel alignment system of example 17, wherein the retention structure includes a retaining channel.
Example 19. The solar panel alignment system of example 17, wherein the retention structure includes a flexible structure with a retaining button or flexure lock.
Example 20. The solar panel alignment system of example 17, wherein the retention structure includes an over-center linkage assembly.
Example 21. The solar panel alignment system of any one of examples 1-20, wherein the bi-directional panel mounts are attachable to, attached to, or integrated with a plurality of torque tube clamps, and the torque tube clamps are attachable to, or attached to, a torque tube.
Example 22. The solar panel alignment system of any one of examples 1-21, wherein the torque tube clamps include a torque tube collar having an inner surface geometry that when locked on the torque tube having an at least partially matching cross-sectional outer surface geometry, the bi-directional panel mounts are prevented from rotating about the torque tube by slippage, and only rotate about the torque tube in coordination with the rotational movement of the torque tube.
Example 23. The solar panel alignment system of any one of examples 1-22, wherein the alignment structure is a male structure adapted to be received by a panel support aperture, where the solar panel alignment system also includes an automated panel insertion vehicle configured to form the panel support aperture to align with the male structure and to install the first solar panel in lateral alignment with the second solar panel.
Example 24. The solar panel alignment system of any one of examples 1-23, wherein the alignment system provides for solar panel alignment during installation in three directions, including:
a) alignment of the lateral edges of adjacently installed solar panels, wherein the lateral edges are positioned in parallel with the torque tube;
b) centering alignment of individual solar panels to provide substantially equal spacing between adjacently installed solar panels; and
c) rotational alignment of installed solar panels to follow rotation of the torque tube without rotational slippage.
Example 25. The solar panel alignment system of any one of examples 1-24, wherein the alignment system provides for solar panel alignment when installed via automation.
Example 26. The solar panel alignment system of any one of examples 1-25, wherein the first and second support panel are frameless solar panels supported by the first and second support rails, respectively.
Example 27. The solar panel alignment system of any one of examples 1-25, wherein the first and second support panel are framed solar panels supported by the first and second support frames, respectively.
Example 28. A solar panel alignment system, comprising:

a plurality of panel mounts connectable or connected to a torque tube, the panel mounts each including a first retaining feature assembly to receive a first side of a first support frame or a first support rail of a first solar panel, and a second retaining feature assembly configured to receive a second side of a second support frame or second support rail of a second solar panel; and

an automated solar panel insertion vehicle adapted to sequentially install solar panels along the torque tube using an automated solar panel insertion vehicle including:
sensory equipment for sensing alignment or misaligned lateral edges of a plurality of solar panels being installed into the plurality of panel mounts when connected to the torque tube, wherein the sensory equipment communicates with installation mechanisms to adjust the misaligned lateral edges of one or more of the multiple solar panels based on data collected by the sensory equipment,
mechanical guides for installation alignment, or
both.
Example 29. The solar panel alignment system of example 28, wherein the sensory equipment includes one or more of an alignment laser or a perception sensor.
Example 30. The solar panel alignment system of any one of examples 28-29, wherein the first retaining feature assembly, the second retaining feature assembly, or both, include a retaining feature selected from a fixed retaining channel, a biasing structure, a pivoting retaining channel, a spring-loaded pin, a fixed pin functionally coupled with a biasing structure, a rotatable pin assembly, a levered pin assembly, a flexible structure with a retaining button, a lead-in latch assembly, a panel-side snap, or a combination thereof.
Example 31. The solar panel alignment system of any one of examples 28-30, wherein the panel mounts are bi-directional panel mounts, and the first retaining feature, the second retaining feature, or both, include multiple retaining features, including at least one alignment structure and at least one retention structure.
Example 32. The solar panel alignment system of any one of examples 28-31, wherein the automated panel insertion vehicle is adapted to align the misaligned lateral edges of the one or more solar panels such that the lateral edges are aligned in parallel with the torque tube.
Example 33. The solar panel alignment system of any one of examples 28-32, wherein the first and second support panel are frameless solar panels supported by the first and second support rails, respectively.
Example 34. The solar panel alignment system of any one of examples 28-32, wherein the first and second support panel are framed solar panels supported by the first and second support frames, respectively.
Example 35. A method of installing and aligning solar panels, comprising:

coupling a plurality of bi-directional panel mounts at multiple locations along an elongated torque tube, with distance intervals suitable for receiving and retaining a plurality of solar panels individually installed between immediately adjacent bi-directional panel mounts, wherein the plurality of bi-directional panel mounts include a first retaining feature assembly to receive a first side of a first support frame or a first support rail of a first solar panel, and a second retaining feature assembly configured to receive a second side of a second support frame or second support rail of a second solar panel, wherein one or both of the first retaining feature assembly or the second retaining feature assembly includes an alignment structure to ensure lateral edges of the first solar panel are aligned with lateral edges of the second solar panel when the first solar panel and the second solar panel are fully engaged with the first retaining feature and the second retaining feature, respectively; and

installing the plurality of solar panels between the immediately adjacent bi-directional panel mounts, to engage with the first retaining feature, the second retaining feature, or both such that the first solar panel and the second solar panel are laterally aligned.
Example 36. The method of example 35, wherein the lateral edges of the first and second solar panels are aligned in parallel with the torque tube.
Example 37. The method of any one of examples 35-36, wherein the first retaining feature assembly or the second retaining feature assembly includes a biasing structure to provide consistent centering and substantially equal spacing between adjacently installed solar panels.
Example 38. The method of any one of examples 35-37, wherein the alignment structure includes a pin or protrusion adapted to be received by a panel support aperture when installing the solar panel, wherein the pin or protrusion and the panel support aperture are each positioned to ensure alignment of the lateral edges of adjacently installed solar panels.
Example 39. The method of example 38, wherein the alignment structure of the first retaining feature assembly includes a first fixed pin and the second retaining feature assembly includes a second fixed pin that is shorter in length than the first fixed pin, and wherein the first retaining feature assembly also includes a biasing structure or spring.
Example 40. The method of example 38, wherein the pin or protrusion includes a spring-loaded pin.
Example 41. The method of example 40, wherein the spring-loaded pin is associated with an engagement lever that engages with a solar panel being installed at one or both of the first or second retaining feature assemblies.
Example 42. The method of example 40, wherein the spring-loaded pin is associated with a rotatable pin assembly that engages with a solar panel being installed at one or both of the first or second retaining feature assemblies.
Example 43. The method of example 40, wherein the spring-loaded pin is associated with a multi-level engagement pin or a toggle-type engagement pin.
Example 44. The method of example 40, wherein pin or protrusion is part of a lead-in latch assembly.
Example 45. The method of example 44, wherein the lead-in latch assembly includes a facial lead-in latch and an edge lead-in latch as part of the first retaining feature assembly.
Example 46. The method of example 45, wherein the lead-in latch assembly includes a second facial lead-in latch as part of the second retaining feature assembly.
Example 47. The method of any one of examples 35-46, wherein the alignment structure includes a flexible structure with a retaining button that engages with a panel support aperture, wherein the retaining button and the panel support aperture are each positioned to ensure alignment of the lateral edges of adjacently installed solar panels.
Example 48. The method of any one of examples 35-47, wherein the alignment structure includes a panel-side snap including a flexible standoff and a retaining button that engages with a panel support aperture, wherein the panel-side snap and the panel support aperture are each positioned to ensure alignment of the lateral edges of adjacently installed solar panels.
Example 49. The method of any one of examples 35-48, wherein the alignment structure includes a retaining channel with a stopper structure suitable for ensuring that a solar panel is not installed laterally beyond the stopper structure.
Example 50. The method of any one of examples 35-49, wherein the alignment structure is present as part of an over-center linkage assembly that is present during installation of a solar panel at least prior to locking the over-center linkage assembly.
Example 51. The method of any one of examples 35-30, wherein in addition to the alignment structure, at least one of the first retaining feature assembly or the second retaining feature assembly includes retention structure to retain the solar panel at the support frame or support rail.
Example 52. The method of example 51, wherein the retention structure includes a retaining channel.
Example 53. The method of example 51, wherein the retention structure includes a flexible structure with a retaining button or flexure lock.
Example 54. The method of example 51, wherein the retention structure includes an over-center linkage assembly.
Example 55. The method of any one of examples 35-54, wherein the bi-directional panel mounts are attachable to, attached to, or integrated with a plurality of torque tube clamps, and the torque tube clamps are attachable to, or attached to, a torque tube.
Example 56. The method of any one of examples 35-55, wherein the torque tube clamps include a torque tube collar having an inner surface geometry that when locked on the torque tube having an at least partially matching cross-sectional outer surface geometry, the bidirectional panel mounts are prevented from rotating about the torque tube by slippage, and only rotate about the torque tube in coordination with the rotational movement of the torque tube.
Example 57. The method of any one of examples 35-56, wherein the alignment system provides for solar panel alignment during installation in three directions, including:
a) alignment of the lateral edges of adjacently installed solar panels, wherein the lateral edges are positioned in parallel with the torque tube;
b) centering alignment of individual solar panels to provide substantially equal spacing between adjacently installed solar panels; and
c) rotational alignment of installed solar panels to follow rotation of the torque tube without rotational slippage.
Example 58. The method of any one of examples 35-57, wherein the alignment system provides for solar panel alignment when installed via automation.
Example 59. A method of aligning and installing solar panels, comprising:

coupling a plurality of panel mounts at multiple locations along an elongated torque tube at distance intervals suitable for receiving and retaining a plurality of solar panels individually installed between immediately adjacent panel mounts, wherein the plurality of panel mounts include a first retaining feature assembly to receive a first side of a first support frame or a first support rail of a first solar panel, and a second retaining feature assembly configured to receive a second side of a second support frame or second support rail of a second solar panel; and

installing the plurality of solar panels between the immediately adjacent panel mounts using an automated solar panel insertion vehicle including:
sensory equipment for sensing alignment or misaligned a plurality of solar panels being installed into the plurality of panel mounts when connected to the torque tube, wherein the sensory equipment communicates with installation mechanisms to adjust the misaligned lateral edges of one or more of the multiple solar panels based on data collected by the sensory equipment,
mechanical guides for installation alignment, or
both.
Example 60. The method of example 59, wherein the sensory equipment includes one or more of an alignment laser or a perception sensor.
Example 61. The method of any one of examples 59-60, wherein the first retaining feature assembly, the second retaining feature assembly, or both, include a retaining feature selected from a fixed retaining channel, a biasing structure, a pivoting retaining channel, a spring-loaded pin, a fixed pin functionally coupled with a biasing structure, a rotatable pin assembly, a levered pin assembly, a flexible structure with a retaining button, a lead-in latch assembly, a panel-side snap, or a combination thereof.
Example 62. The method of any one of examples 59-61, wherein the panel mounts are bi-directional panel mounts, and the first retaining feature, the second retaining feature, or both, include multiple retaining features, including at least one alignment structure and at least one retention structure.
Example 63. The method of any one of examples 59-62, wherein the automated panel insertion vehicle is adapted to align misaligned solar panels such that the lateral edges are aligned in parallel with the torque tube.
Example 64. The method of any one of examples 59-63, wherein the sensory equipment is adapted to detect one or more fiducial associated with the sensory equipment, the plurality of solar panels, the panel mounts, or a combination thereof.
Example 65. The method of example 64, wherein the fiducials are detectable by the sensory equipment using a camera, LIDAR, a IR-based sensor, an ultrasonic sensor, structured light, or a combination thereof.
Example 66. The method of example 64, wherein the fiducial includes a ferromagnetic element detectable by a magnet-based sensor or a Hall Effect sensor.
Example 67. The method of example 64, wherein the fiducial includes an RFID tag detectable by an RFID tag sensor.
Example 68. The method of example 64, wherein the fiducial includes a physical marking that reflects electromagnetic energy.
Example 69. The method of example 68, wherein the electromagnetic energy is reflected from the fiducial with a change in optical properties.
Example 70. The method of example 68, wherein a wavelength shift of the) electromagnetic energy indicates either alignment or misalignment.

While the foregoing examples are illustrative of the principles of the present invention in one or more particular applications, it will be apparent to those of ordinary skill in the art that numerous modifications in form, usage and details of implementation can be made without the exercise of inventive faculty, and without departing from the principles and concepts of the invention.

The term “comprising” is used throughout to mean including at least the recited feature(s) such that any greater number of the same feature and/or additional types of other features are not precluded. It will also be appreciated that specific embodiments have been described herein for purposes of illustration, but that various modifications can be made without deviating from the technology. Further, while advantages associated with some embodiments of the present technology have been described in the context of those embodiments, other embodiments can also exhibit such advantages, and not all embodiments need necessarily exhibit such advantages to fall within the scope of the technology. Accordingly, the disclosure and associated present technology can encompass other embodiments not expressly shown or described herein.

Moreover, unless the word “or” is expressly limited to mean only a single item exclusive from other items in reference to a list of two or more items, then the use of “or” in such a list is to be interpreted as including (a) any single item in the list, (b) all of the items in the list, or (c) any combination of the items in the list. In other words, the use of “or” in this disclosure should be understood to mean non-exclusive “or” (i.e., “and/or”) unless otherwise indicated herein.

Although the subject matter has been described in language specific to structural features and/or operations, it is to be understood that the subject matter defined in the appended claims is not necessarily limited to the specific features and operations described above. Rather, the specific features and acts described above are disclosed as example forms of implementing the claims. Numerous modifications and alternative arrangements may be devised without departing from the spirit and scope of the described present technology.

What is claimed is:

1. A solar panel alignment system, comprising a plurality of bi-directional panel mounts connected to or connectable to a torque tube, the bi-directional panel mounts each including a first retaining feature assembly to receive a first side of a first support frame or a first support rail of a first solar panel, and a second retaining feature assembly configured to receive a second side of a second support frame or second support rail of a second solar panel, wherein one or both of the first retaining feature assembly or the second retaining feature assembly includes an alignment structure to ensure lateral edges of the first solar panel are aligned with lateral edges of the second solar panel when the first solar panel and the second solar panel are fully engaged with the first retaining feature and the second retaining feature, respectively.

2. The solar panel alignment system of claim 1, wherein the lateral edges of the first and second solar panels are aligned in parallel with the torque tube.

3. The solar panel alignment system of claim 1, wherein the first retaining feature assembly or the second retaining feature assembly includes a biasing structure to provide consistent centering and substantially equal spacing between adjacently installed solar panels.

4. The solar panel alignment system of claim 1, wherein the alignment structure includes a pin or protrusion adapted to be received by a panel support aperture when installing the solar panel, wherein the pin or protrusion and the panel support aperture are each positioned to ensure alignment of the lateral edges of adjacently installed solar panels.

5. The solar panel alignment system of claim 4, wherein the alignment structure of the first retaining feature assembly includes a first fixed pin and the second retaining feature assembly includes a second fixed pin that is shorter in length than the first fixed pin, and wherein the first retaining feature assembly also includes a biasing structure or spring.

6. The solar panel alignment system of claim 4, wherein the pin or protrusion includes a spring-loaded pin.

7. The solar panel alignment system of claim 6, wherein the spring-loaded pin is associated with an engagement lever that engages with a solar panel being installed at one or both of the first or second retaining feature assemblies.

8. The solar panel alignment system of claim 6, wherein the spring-loaded pin is associated with a rotatable pin assembly that engages with a solar panel being installed at one or both of the first or second retaining feature assemblies.

9. The solar panel alignment system of claim 6, wherein the spring-loaded pin is associated with a multi-level engagement pin or a toggle-type engagement pin.

10. The solar panel alignment system of claim 4, wherein pin or protrusion is part of a lead-in latch assembly.

11. The solar panel alignment system of claim 10, wherein the lead-in latch assembly includes a facial lead-in latch and an edge lead-in latch as part of the first retaining feature assembly.

12. The solar panel alignment system of claim 11, wherein the lead-in latch assembly includes a second facial lead-in latch as part of the second retaining feature assembly.

13. The solar panel alignment system of claim 1, wherein the alignment structure includes a flexible structure with a retaining button that engages with a panel support aperture, wherein the retaining button and the panel support aperture are each positioned to ensure alignment of the lateral edges of adjacently installed solar panels.

14. The solar panel alignment system of claim 1, wherein the alignment structure includes a panel-side snap including a flexible standoff and a retaining button that engages with a panel support aperture, wherein the panel-side snap and the panel support aperture are each positioned to ensure alignment of the lateral edges of adjacently installed solar panels.

15. The solar panel alignment system of claim 1, wherein the alignment structure includes a retaining channel with a stopper structure suitable for ensuring that a solar panel is not installed laterally beyond the stopper structure.

16. The solar panel alignment system of claim 1, wherein the alignment structure is present as part of an over-center linkage assembly that is present during installation of a solar panel at least prior to locking the over-center linkage assembly.

17. The solar panel alignment system of claim 1, wherein in addition to the alignment structure, at least one of the first retaining feature assembly or the second retaining feature assembly includes retention structure to retain the solar panel at the support frame or support rail.

18. The solar panel alignment system of claim 17, wherein the retention structure includes a retaining channel.

19. The solar panel alignment system of claim 17, wherein the retention structure includes a flexible structure with a retaining button or flexure lock.

20. The solar panel alignment system of claim 17, wherein the retention structure includes an over-center linkage assembly.

21. The solar panel alignment system of claim 1, wherein the bi-directional panel mounts are attachable to, attached to, or integrated with a plurality of torque tube clamps, and the torque tube clamps are attachable to, or attached to, a torque tube.

22. The solar panel alignment system of claim 1, wherein the torque tube clamps include a torque tube collar having an inner surface geometry that when locked on the torque tube having an at least partially matching cross-sectional outer surface geometry, the bi-directional panel mounts are prevented from rotating about the torque tube by slippage, and only rotate about the torque tube in coordination with the rotational movement of the torque tube.

23. The solar panel alignment system of claim 1, wherein the alignment structure is a male structure adapted to be received by a panel support aperture, where the solar panel alignment system also includes an automated panel insertion vehicle configured to form the panel support aperture to align with the male structure and to install the first solar panel in lateral alignment with the second solar panel.

24. The solar panel alignment system of claim 1, wherein the alignment system provides for solar panel alignment during installation in three directions, including:
a) alignment of the lateral edges of adjacently installed solar panels, wherein the lateral edges are positioned in parallel with the torque tube;
b) centering alignment of individual solar panels to provide substantially equal spacing between adjacently installed solar panels; and
c) rotational alignment of installed solar panels to follow rotation of the torque tube without rotational slippage.

25. The solar panel alignment system of claim 1, wherein the alignment system provides for solar panel alignment when installed via automation.

26. The solar panel alignment system of claim 1, wherein the first and second support panel are frameless solar panels supported by the first and second support rails, respectively.

27. The solar panel alignment system of claim 1, wherein the first and second support panel are framed solar panels supported by the first and second support frames, respectively.

28. A solar panel alignment system, comprising:
a plurality of panel mounts connectable or connected to a torque tube, the panel mounts each including a first retaining feature assembly to receive a first side of a first support frame or a first support rail of a first solar panel, and a second retaining feature assembly configured to receive a second side of a second support frame or second support rail of a second solar panel; and
an automated solar panel insertion vehicle adapted to sequentially install solar panels along the torque tube using an automated solar panel insertion vehicle including:
sensory equipment for sensing alignment or misaligned lateral edges of a plurality of solar panels being installed into the plurality of panel mounts when connected to the torque tube, wherein the sensory equipment communicates with installation mechanisms to adjust the misaligned lateral edges of one or more of the multiple solar panels based on data collected by the sensory equipment,
mechanical guides for installation alignment, or
both.

29. The solar panel alignment system of claim 28, wherein the sensory equipment includes one or more of an alignment laser or a perception sensor.

30. The solar panel alignment system of claim 28, wherein the first retaining feature assembly, the second retaining feature assembly, or both, include a retaining feature selected from a fixed retaining channel, a biasing structure, a pivoting retaining channel, a spring-loaded pin, a fixed pin functionally coupled with a biasing structure, a rotatable pin assembly, a levered pin assembly, a flexible structure with a retaining button, a lead-in latch assembly, a panel-side snap, or a combination thereof.

31. The solar panel alignment system of claim 28, wherein the panel mounts are bi-directional panel mounts, and the first retaining feature, the second retaining feature, or both, include multiple retaining features, including at least one alignment structure and at least one retention structure.

32. The solar panel alignment system of claim 28, wherein the automated panel insertion vehicle is adapted to align the misaligned lateral edges of the one or more solar panels such that the lateral edges are aligned in parallel with the torque tube.

33. The solar panel alignment system of claim 28, wherein the first and second support panel are frameless solar panels supported by the first and second support rails, respectively.

34. The solar panel alignment system of claim 28, wherein the first and second support panel are framed solar panels supported by the first and second support frames, respectively.

35. A method of installing and aligning solar panels, comprising:
coupling a plurality of bi-directional panel mounts at multiple locations along an elongated torque tube, with distance intervals suitable for receiving and retaining a plurality of solar panels individually installed between immediately adjacent bi-directional panel mounts, wherein the plurality of bi-directional panel mounts include a first retaining feature assembly to receive a first side of a first support frame or a first support rail of a first solar panel, and a second retaining feature assembly configured to receive a second side of a second support frame or second support rail of a second solar panel, wherein one or both of the first retaining feature assembly or the second retaining feature assembly includes an alignment structure to ensure lateral edges of the first solar panel are aligned with lateral edges of the second solar panel when the first solar panel and the second solar panel are fully engaged with the first retaining feature and the second retaining feature, respectively; and
installing the plurality of solar panels between the immediately adjacent bi-directional panel mounts, to engage with the first retaining feature, the second retaining feature, or both such that the first solar panel and the second solar panel are laterally aligned.

36. The method of claim 35, wherein the lateral edges of the first and second solar panels are aligned in parallel with the torque tube.

37. The method of claim 35, wherein the first retaining feature assembly or the second retaining feature assembly includes a biasing structure to provide consistent centering and substantially equal spacing between adjacently installed solar panels.

38. The method of claim 35, wherein the alignment structure includes a pin or protrusion adapted to be received by a panel support aperture when installing the solar panel, wherein the pin or protrusion and the panel support aperture are each positioned to ensure alignment of the lateral edges of adjacently installed solar panels.

39. The method of claim 35, wherein the alignment structure of the first retaining feature assembly includes a first fixed pin and the second retaining feature assembly includes a second fixed pin that is shorter in length than the first fixed pin, and wherein the first retaining feature assembly also includes a biasing structure or spring.

40. The method of claim 35, wherein the pin or protrusion includes a spring-loaded pin.

41. The method of claim 40, wherein the spring-loaded pin is associated with an engagement lever that engages with a solar panel being installed at one or both of the first or second retaining feature assemblies.

42. The method of claim 40, wherein the spring-loaded pin is associated with a rotatable pin assembly that engages with a solar panel being installed at one or both of the first or second retaining feature assemblies.

43. The method of claim 40, wherein the spring-loaded pin is associated with a multi-level engagement pin or a toggle-type engagement pin.

44. The method of claim 40, wherein pin or protrusion is part of a lead-in latch assembly.

45. The method of claim 40, wherein the lead-in latch assembly includes a facial lead-in latch and an edge lead-in latch as part of the first retaining feature assembly.

46. The method of claim 45, wherein the lead-in latch assembly includes a second facial lead-in latch as part of the second retaining feature assembly.

47. The method of claim 35, wherein the alignment structure includes a flexible structure with a retaining button that engages with a panel support aperture, wherein the retaining button and the panel support aperture are each positioned to ensure alignment of the lateral edges of adjacently installed solar panels.

48. The method of claim 35, wherein the alignment structure includes a panel-side snap including a flexible standoff and a retaining button that engages with a panel support aperture, wherein the panel-side snap and the panel support aperture are each positioned to ensure alignment of the lateral edges of adjacently installed solar panels.

49. The method of claim 35, wherein the alignment structure includes a retaining channel with a stopper structure suitable for ensuring that a solar panel is not installed laterally beyond the stopper structure.

50. The method of claim 35, wherein the alignment structure is present as part of an over-center linkage assembly that is present during installation of a solar panel at least prior to locking the over-center linkage assembly.

51. The method of claim 35, wherein in addition to the alignment structure, at least one of the first retaining feature assembly or the second retaining feature assembly includes retention structure to retain the solar panel at the support frame or support rail.

52. The method of claim 51, wherein the retention structure includes a retaining channel.

53. The method of claim 51, wherein the retention structure includes a flexible structure with a retaining button or flexure lock.

54. The method of claim 51, wherein the retention structure includes an over-center linkage assembly.

55. The method of claim 35, wherein the bi-directional panel mounts are attachable to, attached to, or integrated with a plurality of torque tube clamps, and the torque tube clamps are attachable to, or attached to, a torque tube.

56. The method of claim 35, wherein the torque tube clamps include a torque tube collar having an inner surface geometry that when locked on the torque tube having an at least partially matching cross-sectional outer surface geometry, the bidirectional panel mounts are prevented from rotating about the torque tube by slippage, and only rotate about the torque tube in coordination with the rotational movement of the torque tube.

57. The method of claim 35, wherein the alignment system provides for solar panel alignment during installation in three directions, including:
a) alignment of the lateral edges of adjacently installed solar panels, wherein the lateral edges are positioned in parallel with the torque tube;
b) centering alignment of individual solar panels to provide substantially equal spacing between adjacently installed solar panels; and
c) rotational alignment of installed solar panels to follow rotation of the torque tube without rotational slippage.

58. The method of claim 35, wherein the alignment system provides for solar panel alignment when installed via automation.

59. A method of aligning and installing solar panels, comprising:
coupling a plurality of panel mounts at multiple locations along an elongated torque tube, with distance intervals suitable for receiving and retaining a plurality of solar panels individually installed between immediately adjacent panel mounts, wherein the plurality of panel mounts include a first retaining feature assembly to receive a first side of a first support frame or a first support rail of a first solar panel, and a second retaining feature assembly configured to receive a second side of a second support frame or second support rail of a second solar panel; and
installing the plurality of solar panels between the immediately adjacent panel mounts using an automated solar panel insertion vehicle including:
sensory equipment for sensing alignment or misaligned a plurality of solar panels being installed into the plurality of panel mounts when connected to the torque tube, wherein the sensory equipment communicates with installation mechanisms to install the plurality of solar panels in alignment or adjust the misaligned solar panels of one or more of the multiple solar panels based on data collected by the sensory equipment,
mechanical guides for installation alignment, or
both.

60. The method of claim 59, wherein the sensory equipment includes one or more of an alignment laser or a perception sensor.

61. The method of claim 59, wherein the first retaining feature assembly, the second retaining feature assembly, or both, include a retaining feature selected from a fixed retaining channel, a biasing structure, a pivoting retaining channel, a spring-loaded pin, a fixed pin functionally coupled with a biasing structure, a rotatable pin assembly, a levered pin assembly, a flexible structure with a retaining button, a lead-in latch assembly, a panel-side snap, or a combination thereof.

62. The method of claim 59, wherein the panel mounts are bi-directional panel mounts, and the first retaining feature, the second retaining feature, or both, include multiple retaining features, including at least one alignment structure and at least one retention structure.

63. The method of claim 59, wherein the automated panel insertion vehicle is adapted to align the misaligned solar panels such that the lateral edges are aligned in parallel with the torque tube.

64. The method of claim 59, wherein the sensory equipment is adapted to detect one or more fiducial associated with the sensory equipment, the plurality of solar panels, the panel mounts, or a combination thereof.

65. The method of claim 64, wherein the fiducials are detectable by a camera, LIDAR, a IR-based sensor, an ultrasonic sensor, structured light, or a combination thereof.

66. The method of claim 64, wherein the fiducial includes a ferromagnetic element detectable by a magnet-based sensor or a Hall Effect sensor.

67. The method of claim 64, wherein the fiducial includes an RFID tag detectable by an RFID tag sensor.

68. The method of claim 64, wherein the fiducial includes a physical marking that reflects electromagnetic energy.

69. The method of claim 68, wherein the electromagnetic energy is reflected from the fiducial with a change in optical properties.

70. The method of claim 68, wherein a wavelength shift of the electromagnetic energy indicates either alignment or misalignment.
